(19) United States
(12) Patent Application Publication
(10) Pub. No.: US 2013/0013345 A1
(43) Pub. Date: Jan. 10, 2013

(54) SYSTEMS AND METHODS FOR BUSINESS CLASSIFICATION

(75) Inventors: Dianna M. Wallquist, West Hartford, CT (US); William W. Scarff, Reisterstown, MD (US)

(73) Assignee: THE TRAVELERS COMPANIES, INC., Hartford, CT (US)

(21) Appl. No.: 13/179,464

(22) Filed: Jul. 8, 2011

(51) Int. Cl. G06Q 40/00

(52) U.S. Cl. 705/4

(57) ABSTRACT

Systems, apparatus, interfaces, methods, and articles of manufacture that provide for business classification, such as, for example, determining the nature of a business's operations to allow an accurate assessment of the corresponding risks and potential liabilities.

### BACKGROUND OF THE INVENTION

Underwriters, distributors, agents, or sellers of various products (such as insurance or surety products) often must properly categorize a customer's business (or other information) to develop an accurate rate quote. Unfortunately, a substantial percentage of underwriting decisions are based on incorrect classifications. Such errors in classification may give rise to various adverse consequences such as increased occurrence of losses (e.g., for the underwriter and/or insurer), “premium leakage” (e.g., cases where a policy should have been written for a higher premium—if classified correctly), and/or a distortion of business segment data (which is utilized to determine appropriate premium levels for future underwriting). These and other deficiencies remain unresolved.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3A and FIG. 3B are flow diagrams of methods according to some embodiments;

FIG. 4A, FIG. 4B, FIG. 4C, FIG. 4D, and FIG. 4E are example interfaces according to some embodiments;

FIG. 5A, FIG. 5B, and FIG. 5C are example interfaces according to some embodiments;

FIG. 6 is a flow diagram of a method according to some embodiments;

FIG. 7 is a block diagram of an apparatus according to some embodiments;

FIG. 8A and FIG. 8B are perspective diagrams of example data storage devices according to some embodiments; and

FIG. 9 is a block diagram of an exemplary underwriting system incorporating a system according to some embodiments.

### DETAILED DESCRIPTION

Embodiments described herein are descriptive of systems, apparatus, interfaces, methods, and articles of manufacture for enhanced business classification, such as, for example, determining the nature of a business's operations to allow an accurate assessment of the corresponding risks and potential liabilities. In some embodiments, for example, the process of underwriting (e.g., quoting and/or selling) various products may be enhanced by pre-categorizing or classifying a business (or account or customer)—e.g., so that the underwriter does not have to. In some embodiments, the classification may be changed based on answers to underwriting questions. According to some embodiments, an interface for enhanced business classification may be provided to facilitate and/or improve the underwriting process. In some embodiments, other information and/or metrics may also or alternatively be categorized (and/or re-categorized based on answers to underwriting questions).

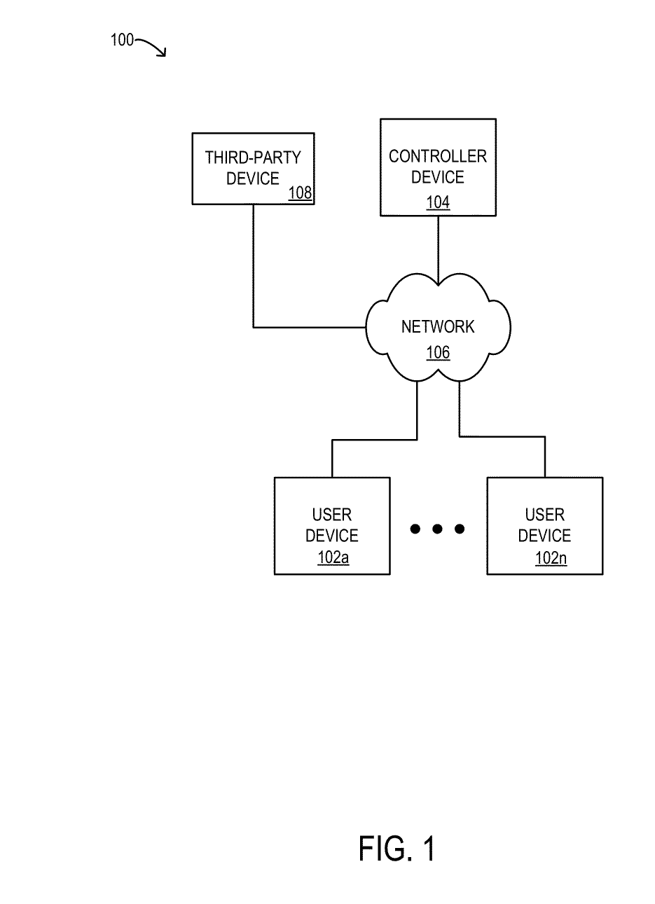

Referring first to FIG. 1, for example, a block diagram of a system 100 according to some embodiments is shown. In some embodiments, the system 100 may comprise a plurality of user devices 102a-n, a controller device 104, a network 106, and/or a third-party device 108. As depicted in FIG. 1, any or all of the devices 102a-n, 104, 108 (or any combinations thereof) may be in communication via the network 106. In some embodiments, the system 100 may be utilized to provide (and/or receive) enhanced (e.g., “smart”) classification of business and/or other data or metrics. The controller device 104 may, for example, interface with one or more of the user devices 102a-n and/or the third-party device 108 to provide automatic business classifications in an effort to make an underwriting process (e.g., conducted and/or initiated by one or more of the user devices 102a-n) more efficient and/or effective.

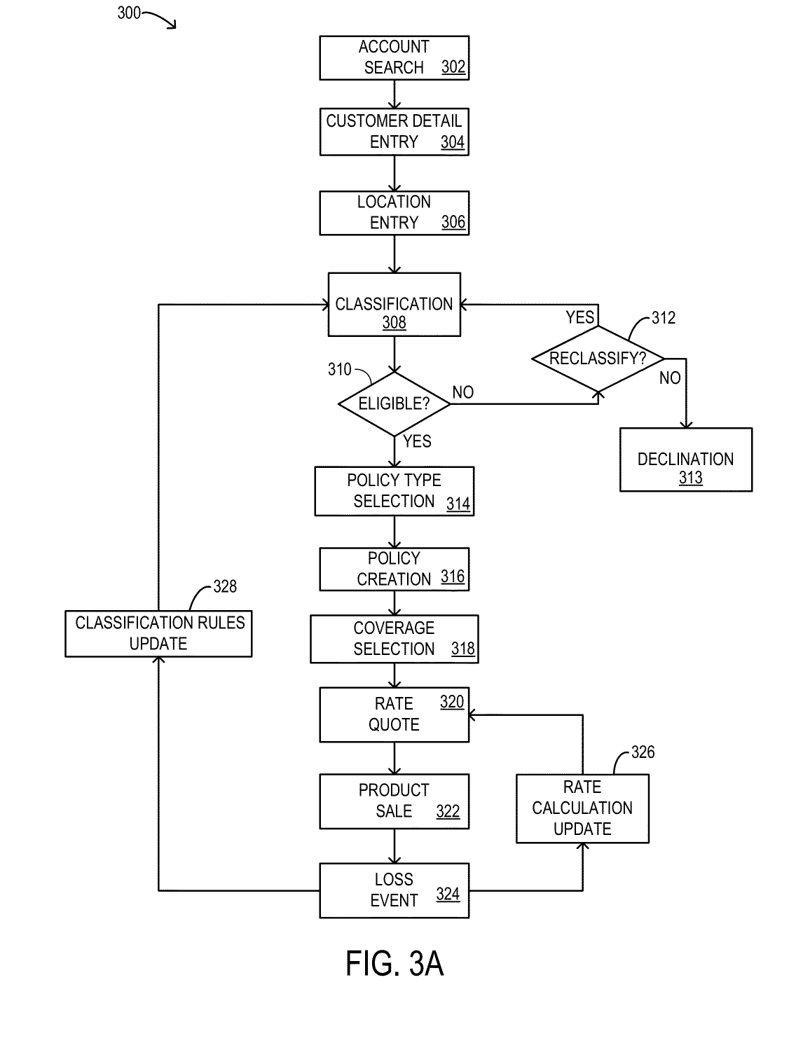

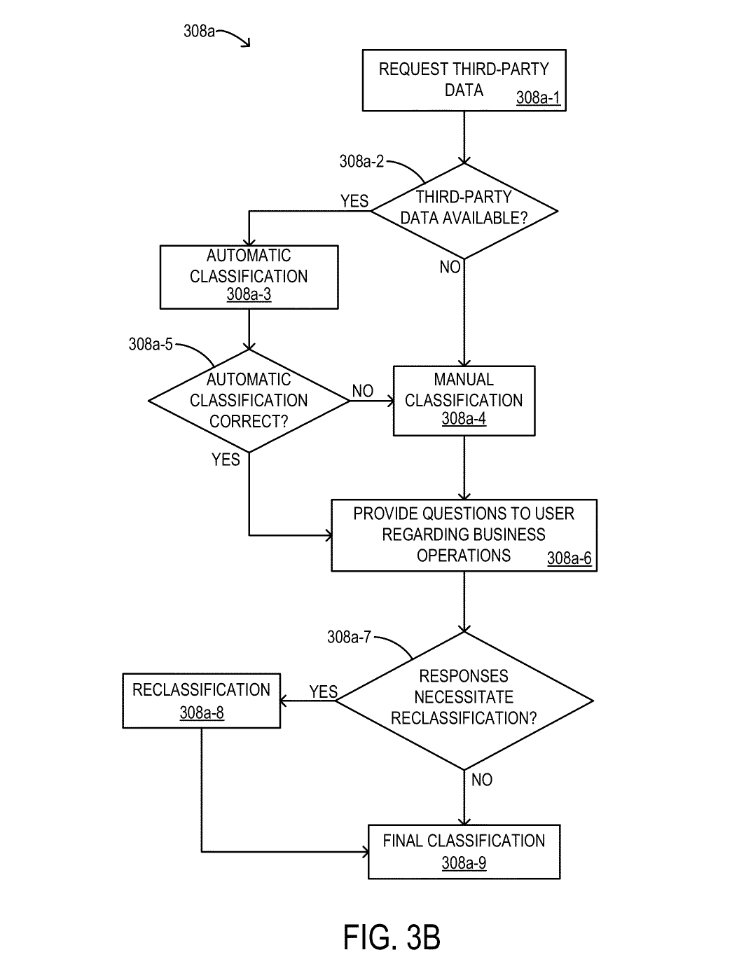

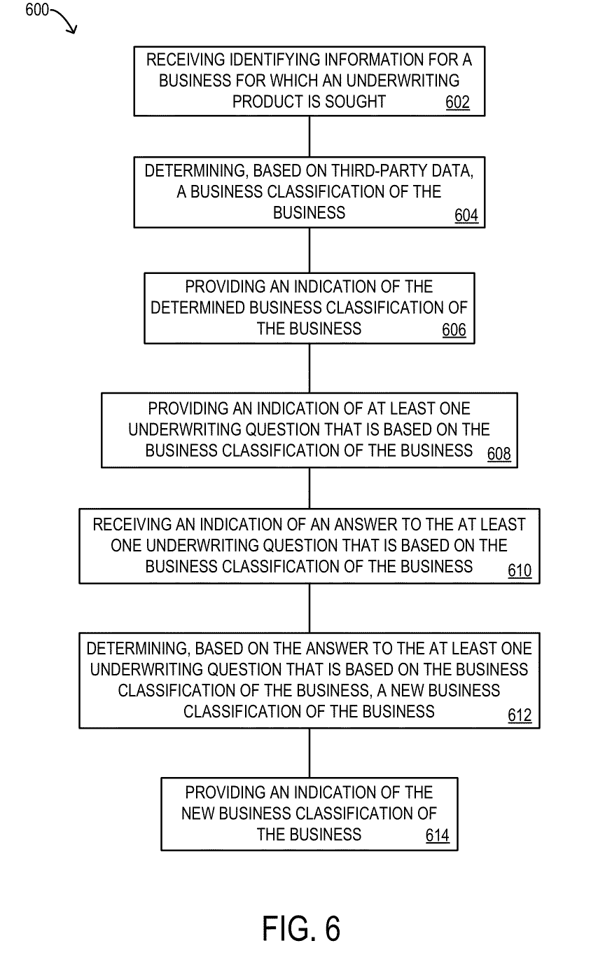

Fewer or more components 102a-n, 104, 106, 108 and/or various configurations of the depicted components 102a-n, 104, 106, 108 may be included in the system 100 without deviating from the scope of embodiments described herein. In some embodiments, the components 102a-n, 104, 106, 108 may be similar in configuration and/or functionality to similarly named and/or numbered components as described herein. In some embodiments, the system 100 (and/or portion thereof) may comprise an underwriting program and/or platform programmed and/or otherwise configured to execute, conduct, and/or facilitate any of the various methods 300, 308a, 600 of FIG. 3A, FIG. 3B, and/or FIG. 6 and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more PC devices, computer workstations (e.g., underwriter workstations), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as underwriters, account managers, agents/brokers, customer service representatives, and/or underwriting product customers. According to some embodiments, the user devices 102a-n may communicate with the controller device 104 via the network 106, such as to conduct underwriting inquiries and/or processes utilizing enhanced or “smart” classifications as described herein. In some embodiments, the user devices 102a-n may interface with the controller device 104 to effectuate communications (direct or indirect) with one or more other user devices 102a-n (such communication not explicitly shown in FIG. 1), such as may be operated by other users. In some embodiments, the user devices 102a-n may interface with the controller device 104 to effectuate communications (direct or indirect) with the third-party device 108 (such communication also not explicitly shown in FIG. 1).

In some embodiments, the controller device 104 may comprise an electronic and/or computerized controller device such as a computer server communicatively coupled to interface with the user devices 102a-n and/or the third-party device 108 (directly and/or indirectly). The controller device 104 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 104 may be located remote from one or more of the user devices 102a-n and/or the third-party device 108. The controller device 104 may also or alternatively comprise a plurality of electronic processing devices located at one or more various sites and/or locations.

According to some embodiments, the controller device 104 may store and/or execute specially programmed instructions to operate in accordance with embodiments described herein. The controller device 104 may, for example, execute one or more programs that facilitate the enhanced or smart classification of underwriting product clients, customers, businesses, products, and/or other associated metrics. According to some embodiments, the controller device 104 may comprise a computerized processing device such as a PC, laptop computer, computer server, and/or other electronic device to manage and/or facilitate transactions and/or communications regarding the user devices 102a-n (e.g., in an attempt to increase the efficiency and effectiveness of underwriting). An underwriter (and/or customer, client, or company) may, for example, utilize the controller device 104 to (i) price and/or underwrite one or more products, such as insurance, indemnity, and/or surety products, (ii) determine and/or be provided with business and/or other classification information in an enhanced manner as described herein, (iii) determine and/or be provided with business classification and/or other reclassification based on answers to underwriting questions, and/or (iv) provide an interface via which an underwriting entity may manage and/or facilitate underwriting of various products (e.g., in accordance with embodiments described herein).

The network 106 may, according to some embodiments, comprise a LAN (wireless and/or wired), cellular telephone, Bluetooth®, and/or RF network with communication links between the controller device 104, the user devices 102a-n, and/or the third-party device 108. In some embodiments, the network 106 may comprise direct communications links between any or all of the components 102a-n, 104, 108 of the system 100. The user devices 102a-n may, for example, be directly interfaced or connected to one or more of the controller device 104 and/or the third-party device 108 via one or more wires, cables, wireless links, and/or other network components, such network components (e.g., communication links) comprising portions of the network 106. In some embodiments, the network 106 may comprise one or many other links or network components other than those depicted in FIG. 1. The user devices 102a-n may, for example, be connected to the controller device 104 via various cell towers, routers, repeaters, ports, switches, and/or other network components that comprise the Internet and/or a cellular telephone (and/or Public Switched Telephone Network (PSTN)) network, and which comprise portions of the network 106.

While the network 106 is depicted in FIG. 1 as a single object, the network 106 may comprise any number, type, and/or configuration of networks that is or becomes known or practicable. According to some embodiments, the network 106 may comprise a conglomeration of different sub-networks and/or network components interconnected, directly or indirectly, by the components 102a-n, 104, 108 of the system 100. The network 106 may comprise one or more cellular telephone networks with communication links between the user devices 102a-n and the controller device 104, for example, and/or may comprise the Internet, with communication links between the controller device 104 and the third-party device 108, for example.

The third-party device 108, in some embodiments, may comprise any type or configuration of a computerized processing device such as a PC, laptop computer, computer server, database system, and/or other electronic device, devices, or any combination thereof. In some embodiments, the third-party device 108 may be owned and/or operated by a third-party (i.e., an entity different than any entity owning and/or operating either the user devices 102a-n or the controller device 104). The third-party device 108 may, for example, be owned and/or operated by a data and/or data service provider such as Dun & Bradstreet® Credibility Corporation (and/or a subsidiary thereof, such as Hoovers™), Deloitte® Development, LLC, Experian™ Information Solutions, Inc., and/or Edmunds.com®, Inc. In some embodiments, the third-party device 108 may supply and/or provide data such as business and/or other classification data to the controller device 104 and/or the user devices 102a-n. In some embodiments, the third-party device 108 may comprise a plurality of devices and/or may be associated with a plurality of third-party entities.

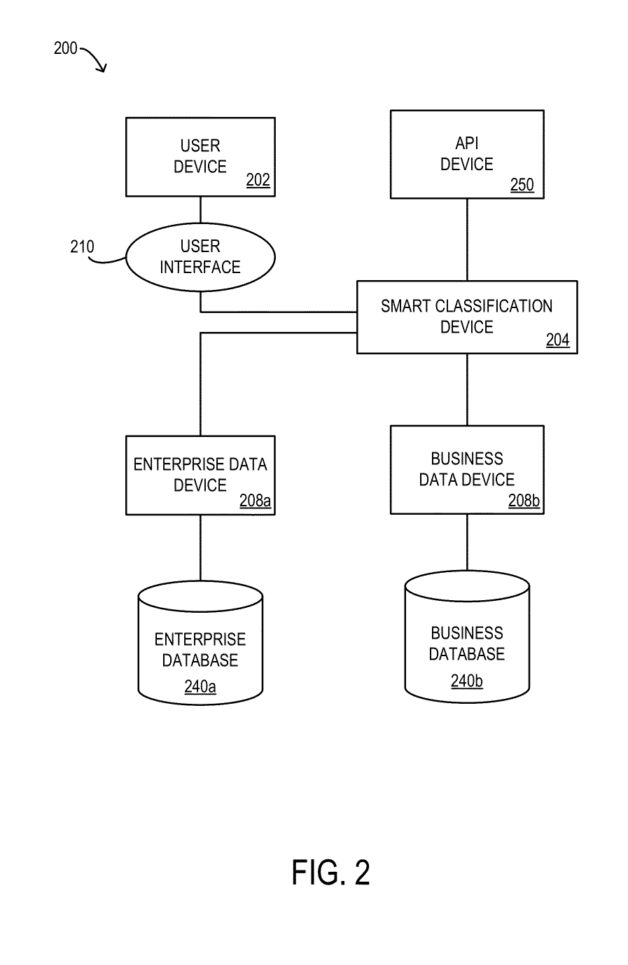

Turning to FIG. 2, a block diagram of a system 200 according to some embodiments is shown. In some embodiments, the system 200 may conduct and/or facilitate smart classification of underwriting metrics. The system 200 may, for example, be similar in configuration and/or functionality to the system 100 of FIG. 1 herein. According to some embodiments, the system 200 may comprise a user device 202 in communication with a smart classification device 204. In some embodiments, the smart classification device 204 may be in communication with one or more data devices 208a-b, such as an enterprise data device 208a and/or a business data device 208b. According to some embodiments, the user device 202 may interact, interface, and/or communicate with the smart classification device 204 via a user interface 210. In some embodiments, the enterprise data device 208a may be in communication with (and/or comprise) an enterprise database 240a and/or the business data device 208b may be in communication with (and/or comprise) a business database 240b. According to some embodiments, the system 200 may comprise an Application Program Interface (API) device 250 in communication with the smart classification device 204.

Fewer or more components 202, 204, 208a-b, 210, 240a-b, 250 and/or various configurations of the depicted components 202, 204, 208a-b, 210, 240a-b, 250 may be included in the system 200 without deviating from the scope of embodiments described herein. In some embodiments, the components 202, 204, 208a-b, 210, 240a-b, 250 may be similar in configuration and/or functionality to similarly named and/or numbered components as described herein. In some embodiments, the system 200 (and/or a portion thereof) may comprise an underwriting program and/or platform programmed and/or otherwise configured to execute, conduct, and/or facilitate any of the various methods 300, 308a, 600 of FIG. 3A, FIG. 3B, and/or FIG. 6 and/or portions or combinations thereof described herein.

In some embodiments, the user device 202 may be utilized (e.g., by a user; not shown) to access the user interface 210. The user interface 210 may, for example, comprise a Graphical User Interface (GUI), such as a web page, form, and/or API provided by (and/or otherwise associated with) the smart classification device 204. According to some embodiments, the user device 202 may comprise a computerized device operated by a user and/or insurance underwriter (not shown) and/or the smart classification device 204 may comprise a server, program (e.g., a web browser plug-in), and/or application (e.g., an underwriting application) configured to facilitate the underwriting (or pricing) process. The user and/or underwriter may, according to some embodiments, provide input via the user device 202 and/or the user interface 210. The input may comprise, for example, an indication of a location, such as a customer and/or business location (and/or indications of other underwriting metrics). In some embodiments, the smart classification device 204 may receive and/or process the input to determine a proper classification of the customer, business, and/or other metric.

The smart classification device 204 may, for example, send and/or provide an indication of the location to either or both of the enterprise data device 208a and the business data device 208b. In some embodiments, the smart classification device 204 may transmit a query to either or both of the enterprise data device 208a and the business data device 208b (e.g., based on the location information). In the case that the enterprise data device 208a is utilized, data regarding the particular business may have been previously processed and/or may already be stored in the enterprise database 240a. The enterprise database 240a may, for example, comprise a data storage device of an entity, institution, and/or business (none of which are explicitly shown) that owns and/or operates the smart classification device 204. The entity may, in some embodiments, comprise an insurance company and/or underwriter associated therewith. The enterprise database 240a may comprise, for example, an enterprise data store of the insurance company and/or underwriter. The enterprise data device 208a may, according to some embodiments, comprise a network component, database component, and/or a Database Access Object (DAO) configured to permit and/or facilitate access to the enterprise database 240a.

In some embodiments, the smart classification device 204 may attempt to acquire business classification (and/or other metric classification) data from the enterprise database 240a (e.g., by interfacing with the enterprise data device 208a). In the case that classification data is determined from the enterprise database 240a, the smart classification device 204 may provide the classification data to the user (and/or user device 202) via the user interface 210. According to some embodiments, the enterprise database 240a may also or alternatively store information descriptive of available classifications and/or descriptions thereof. The enterprise database 240a may, for example, store indications of every possible business classification for a particular underwriting company, business unit, and/or underwriting product type. In some embodiments, such as in the case that classification information cannot be located via the enterprise database 240a (and/or the business database 240b), the user device 202 (and/or the user interface 210) may be utilized to search (e.g., query) the possible classifications. In some embodiments, the searching may comprise keyword, “also-known-as” (A.K.A.), search-as-you-type, drop-down menu, industry code, and/or industry segment searching. According to some embodiments, the enterprise database 240a may store indications of underwriting questions assigned to one or more classifications. In some embodiments, such underwriting questions may be provided to the user device 202 and/or answers thereto (e.g., provided via the user interface 210) may trigger reclassification based on data stored in the enterprise database 240a.

In some embodiments, such as in the case that classification data cannot be identified and/or determined from the enterprise database 240a, the smart classification device 204 may attempt to acquire business classification (and/or other metric classification) data from the business database 240b (e.g., via the business data device 208b). According to some embodiments, the smart classification device 204 may utilize the location information received via the user interface 210 to search for business classification information utilizing the business data device 208b (e.g., by accessing the business database 240b). The business data device 208b and/or the business database 240b may, for example, comprise devices, data stores, and/or network components owned and/or operated by a third-party entity (and/or a plurality of third-parties; e.g., similar to the third-party device 108 of FIG. 1; the entity not being explicitly shown). Such a third-party entity may, in some embodiments, comprise a commercial service that acquires, aggregates, provides, and/or sells access to various information such as demographics, marketing information, credit ratings (and/or other credit and/or financial information), and/or business classifications (such as Standard Industrial Classification (SIC) codes as published by the U.S. Occupational Health & Safety Administration (OSHA) and/or North American Industrial Classification System (NAICS) codes) data. In such a manner, for example, the smart classification device 204 may utilize the location information provided by the user device 202 to query the business database 240b and determine one or more of a SIC code, NAICS code, and/or other industry, business, and/or business segment classification for a particular client, customer, and/or potential underwriting product sale.

In some embodiments, any program code, rules, communications protocols, and/or definitions, modules, objects, and/or any combination thereof that cause and/or facilitate operation of the smart classification device 204 and/or the user interface 210, may be managed, defined, edited, and/or stored via the API device 250. The API device 250 may, for example, comprise a specially-programmed API, program, application, and/or other function or procedure that facilitates creation, setup, and/or execution or management of an underwriting and/or underwriting product pricing tool.

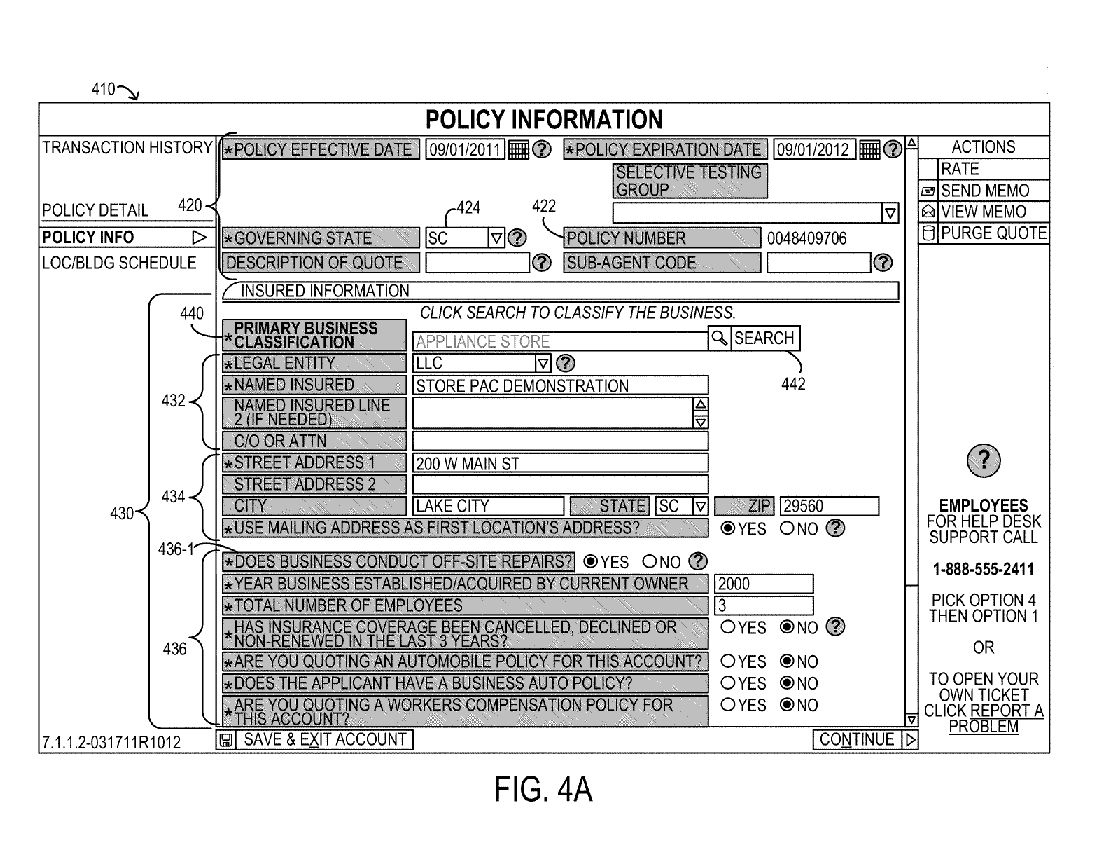

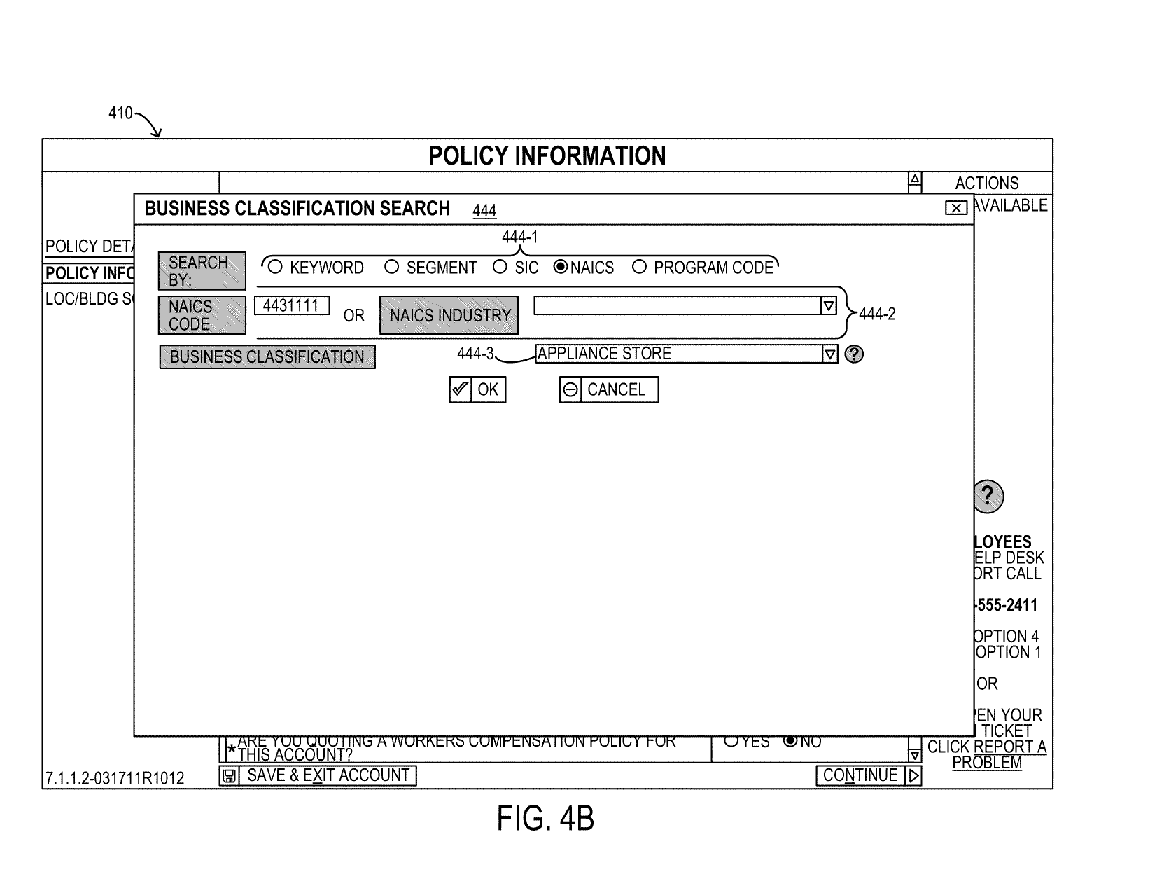

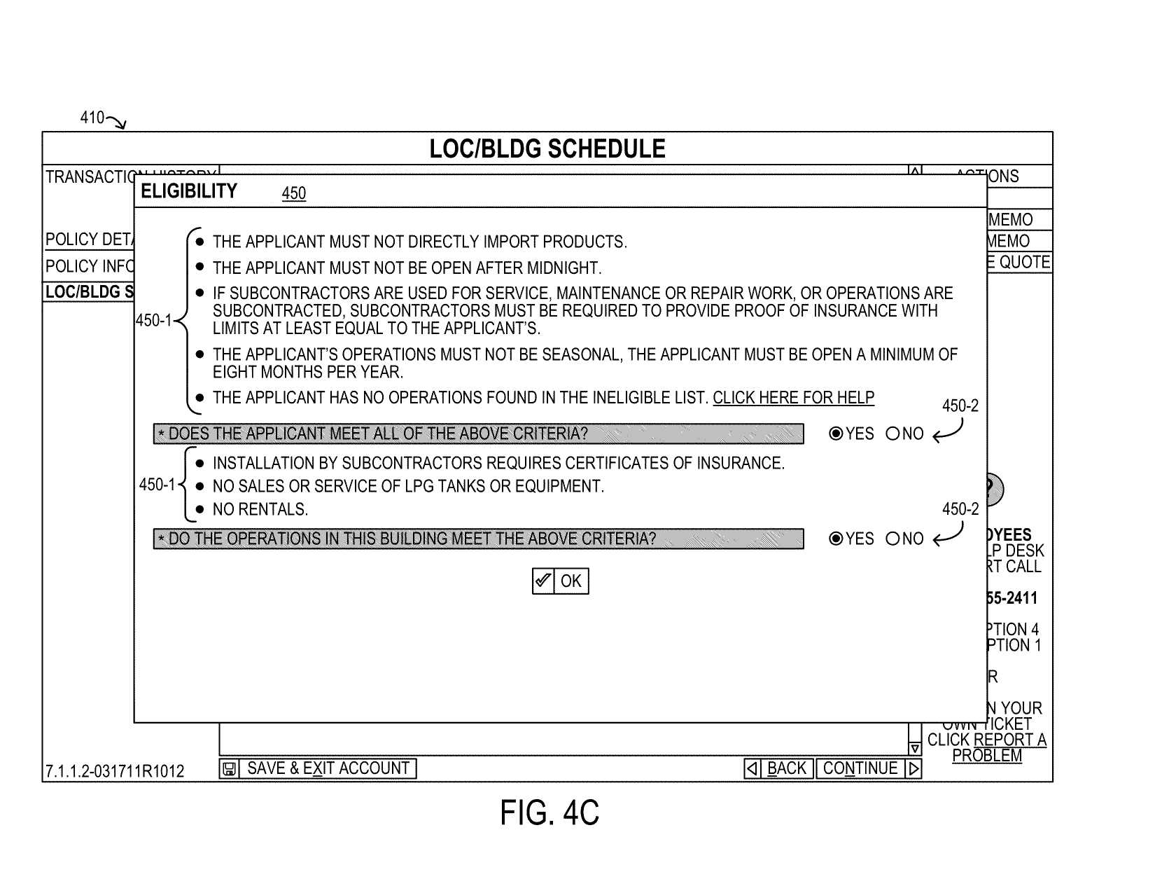

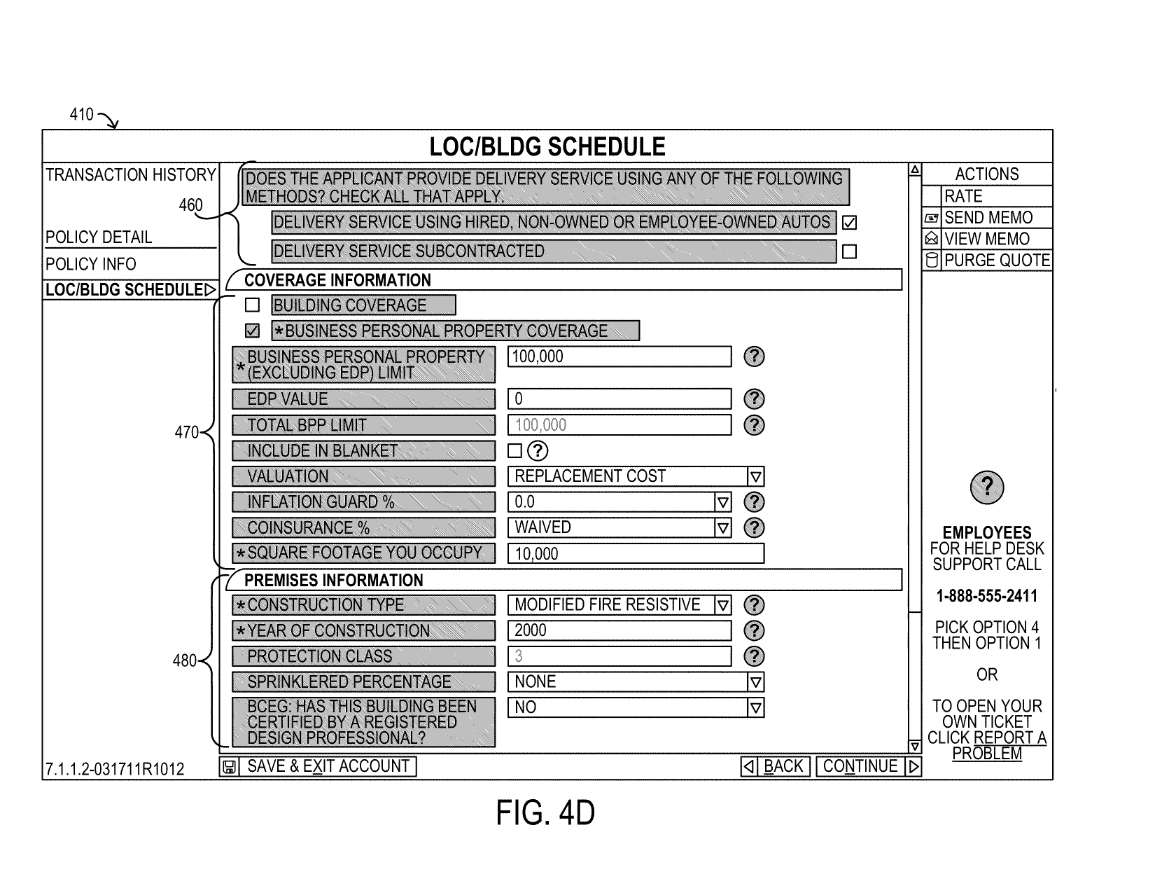

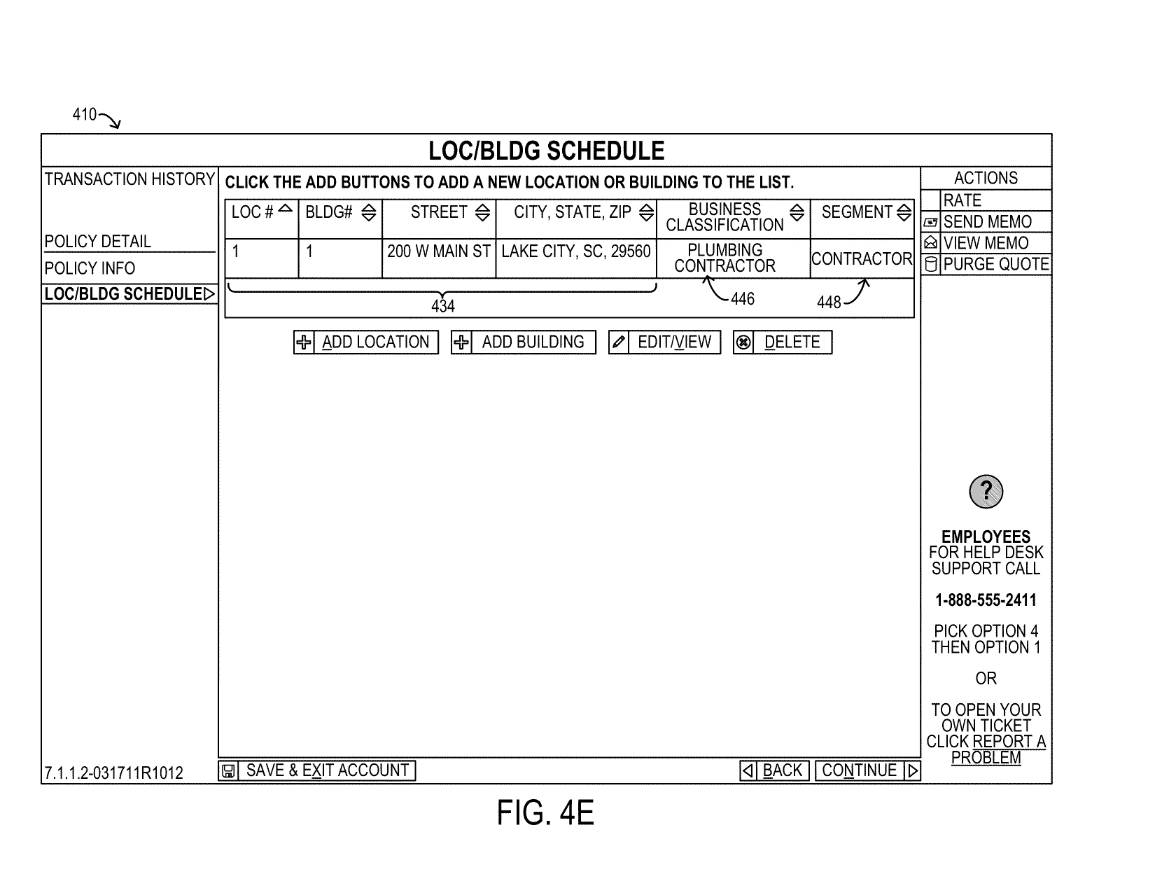

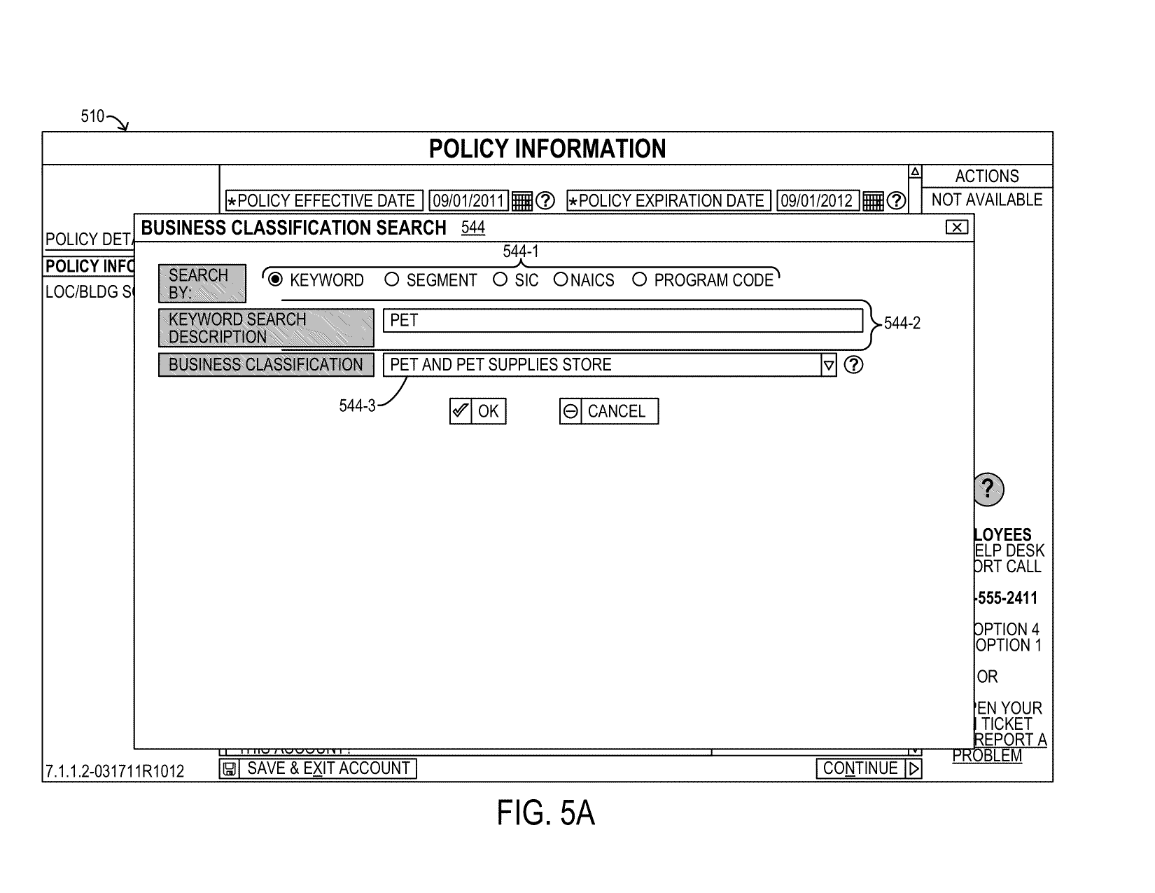

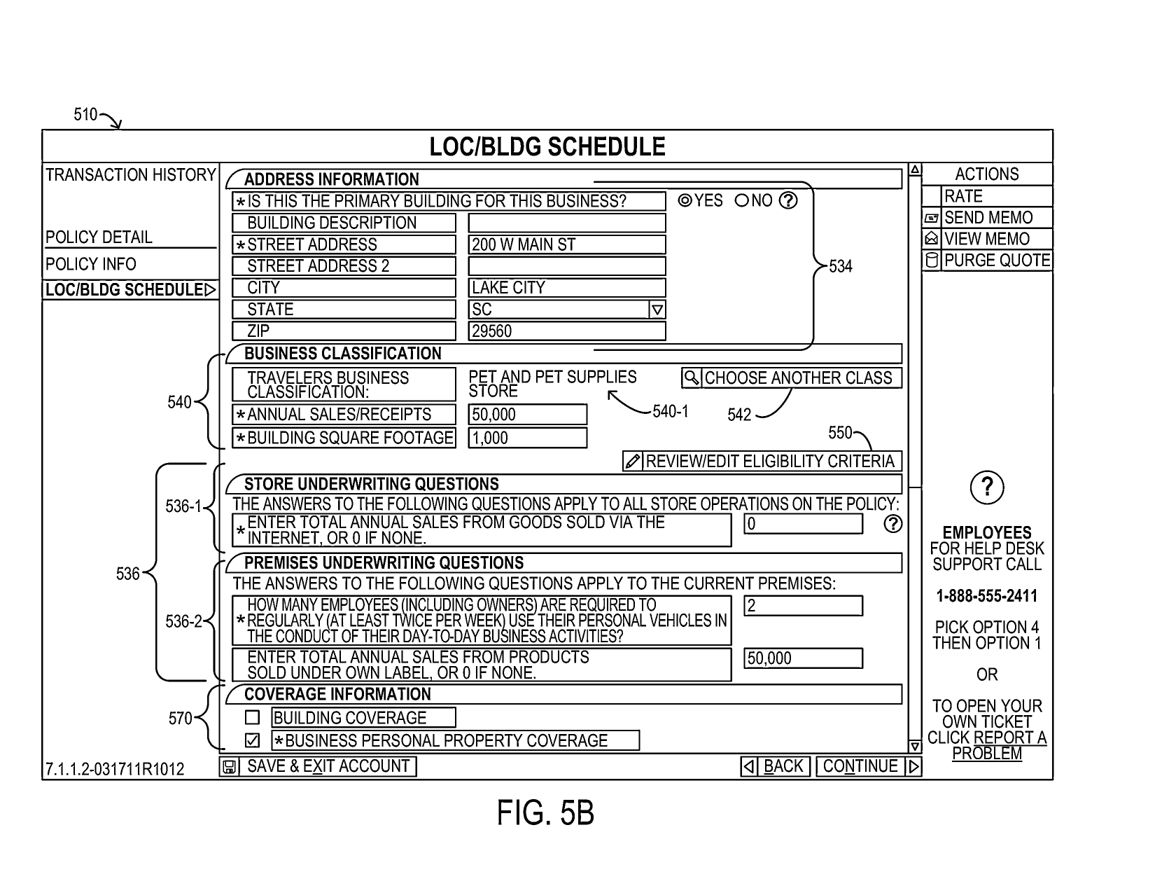

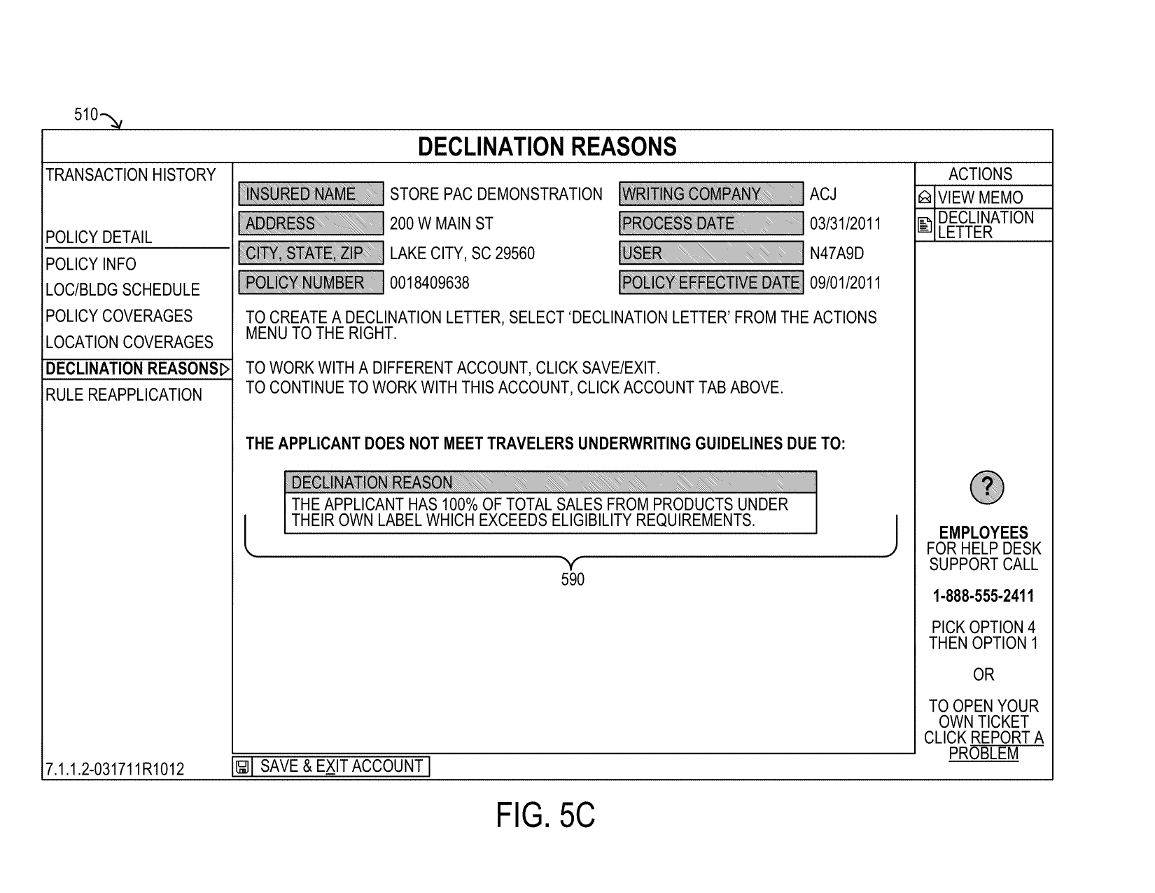

Turning to FIG. 3A and FIG. 3B, flow diagrams of methods 300, 308a according to some embodiments are shown. In some embodiments, the methods 300, 308a may be performed and/or implemented by and/or otherwise associated with one or more specialized and/or computerized processing devices (e.g., the user devices 102a-n, 202 and/or the controller device 104 or smart classification device 204, of FIG. 1 and/or FIG. 2), specialized computers, computer terminals, computer servers, computer systems and/or networks, and/or any combinations thereof (e.g., by one or more insurance company, agent/broker, and/or surety underwriter computers). In some embodiments, the methods 300, 308a may be embodied in, facilitated by, and/or otherwise associated with various input mechanisms and/or interfaces such as the example interfaces 210, 410, 510 described with respect to FIG. 2, FIG. 4A, FIG. 4B, FIG. 4C, FIG. 4D, FIG. 4E, FIG. 5A, FIG. 5B, and/or FIG. 5C herein. The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments (and referring first to FIG. 3A), the method 300 may be illustrative of a process that occurs when a customer requests a product (e.g., an underwriting product) from an underwriter, customer service representative, distributor, etc. According to some embodiments, the method 300 may be illustrative of a process of self-service underwriting product pricing (such as the customer pricing an insurance policy online). In some embodiments, the method 300 may comprise an account search, at 302. An underwriter and/or customer may, for example, utilize an interface as described herein to search for, identify, and/or otherwise determine an existing account. In some embodiments, the account search may comprise an account login and/or associated credential check (e.g., password-protected account login). The account search 302 may be based, in some embodiments, on a customer name, business name, account number, and/or other identification information that is or becomes known or practicable. In some embodiments, a computerized processing device such as a PC or computer server and/or a software program and/or interface may conduct the account search 302 and/or may receive information descriptive of the account search 302 and/or one or more indications thereof.

According to some embodiments, the method 300 may comprise customer detail entry, at 304. Any appropriate and/or desired employee, agent, and/or other entity associated with a business (e.g., a customer's business and/or an underwriting business) may, for example, input customer information into a software application and/or an interface (e.g., utilizing a computerized processing device as described herein). Such information, according to some embodiments, may comprise (but is not limited to) business profitability, revenues, costs, overhead, default rates (e.g., regarding certain products and/or types of products), exposure, taxes, credit ratings and related information, any other financial and/or operational metric that is or becomes desirable, and/or any combination thereof. In some embodiments, the customer detail/information may comprise qualitative information such as an underwriter's personal assessment of the qualifications of the management team of a customer/customer's company (e.g., as determined through a face-to-face and/or telephonic meeting). In some embodiments, such as in the case that the account search 302 results in an identification of an existing account, the some or all of the customer detail entry 304 may not be required and/or desired (e.g., such information may already be stored in association with the existing account). According to some embodiments, a computerized processing device such as a PC or computer server and/or a software program and/or interface may receive the customer detail entry 304 and/or one or more indications thereof.

In some embodiments, the method 300 may comprise location entry, at 306. The customer and/or underwriter may, for example, enter information descriptive of one or more locations of the customer and/or the customer's business. According to some embodiments, the location information may automatically (and/or otherwise) be determined based on and/or comprise the customer detail entry 304 and/or the account search 302. Information descriptive of the customer/business such as the business name may, for example, be utilized to determine an address and/or other location (e.g., coordinates, directions, etc.) information of the business, which may comprise the location entry 306. In some embodiments, the location entry 306 may comprise determining a location of the customer (and/or underwriter or distributor) and/or a device associated therewith. In the case that the customer (and/or underwriter or distributor) utilizes a device such as a computer or cellular telephone, for example, the user interface (and/or customer interface) and/or program or system may determine location information descriptive of a current location of such a device. Global Positioning System (GPS) data received from the customer's cellular telephone, in some embodiments, may be utilized (e.g., in conjunction with a prompt requesting the customer to indicate whether they are currently at the location of the business) to determine coordinates and/or address information descriptive of the business. Triangulation such as cellular telephone network triangulation and/or other location determination methods (and/or devices) may also or alternatively be utilized to determine a location of the customer (and/or underwriter, such as in the case that the underwriter/distributor is visiting the business location in person to price an underwriting product for the business). In some embodiments, a computerized processing device such as a PC or computer server and/or a software program and/or interface may receive the location entry 306 and/or one or more indications thereof.

According to some embodiments, the method 300 may comprise classification, at 308. The classification 308 may, in some embodiments, be based on the customer detail entry 304 and/or location entry 306. The name and/or location of the business and/or customer may be utilized, for example, to lookup (e.g., utilizing a third-party service and/or device), query, and/or otherwise determine an appropriate class of the business (and/or other desired underwriting metric). In some embodiments, the classification 308 may be conducted by a processing device such as a computer and/or server executing an underwriting program. The classification 308 may, for example, be conducted automatically on behalf of the customer and/or underwriter. In such a manner, errors in classification may be avoided, decrease in frequency and/or magnitude, and/or be appropriately managed through programming of rules and/or policies. According to some embodiments, the classification 308 may comprise outputting and/or providing classification information assigned to the customer and/or business. Classification information may be output via an interface of a user device, for example. In some embodiments, classification information may be provided as a recommendation and/or guide. The provided classification information may be ignored and/or overridden by the customer and/or underwriter, for example. According to some embodiments, the classification 308 may comprise determining a standardized classification code (such as a SIC and/or NAICS code) and cross-referencing the standardized code with one or more proprietary codes, classes, and/or business segments. According to some embodiments, a computerized processing device such as a PC or computer server and/or a software program and/or interface may receive the classification 308 and/or one or more indications thereof.

According to some embodiments (and referring to FIG. 3B), the method 308a may be related to and/or similar to and/or comprise a portion of the method 300 of FIG. 3A. In some embodiments, for example, the method 308a may comprise one manner of conducting the classification 308 of the method 300 of FIG. 3A. As shown in FIG. 3B, the method 308a may comprise requesting third-party data, at 308a-1. The request may be made, for example, in response to receiving and/or determining customer data, such as at the customer detail entry 304, and/or location data, such as at the location entry 306, of the method 300 of FIG. 3A. In some embodiments, the request at 308a-1 may comprise a query and/or lookup utilizing one or more third-party data sources such as described herein. The request at 308a-1 may be directed to obtaining business classification information such as a SIC and/or NAICS code of the queried business. In some embodiments, a determination may be made as to whether third-party data regarding business classification is available or not, at 308a-2. In the case that third-party data is determined to be available, the method 308a may proceed to an automatic classification, at 308a-3. In the case that no third-party data (and/or insufficient third-party data) is determined to be available, the method 308a may proceed to a manual classification, at 308a-4. In the case that automatic classification at 308a-3 is utilized, a determination may be made as to whether the automatic classification is correct, at 308a-5. In the case that the automatic classification is determined to have been incorrect, the method 308a may proceed to the manual classification at 308a-4. In the case that the automatic classification is determined to have been correct and/or upon manual classification at 308a-4, questions may be provided to a user regarding business operations, at 308a-6. In some embodiments, a determination may be made as to whether any responses to the provided questions necessitate reclassification, at 308a-7. In the case that one or more responses are determined to warrant reclassification, the method 308a may proceed to reclassification, at 308a-8. In the case that no reclassification is warranted and/or in the case that reclassification at 308a-8 is completed, the method 308a may proceed to final classification, at 308a-9. The final classification 308a-9 may, for example, provide results similar and/or identical to the classification 308, and/or upon completion thereof, the method 300 may continue as described below.

In some embodiments (and referring again to FIG. 3A), the method 300 may comprise a determination of whether a customer, business, policy, and/or product is eligible (e.g. within the risk appetite of an insurer), at 310. Based on the classification 308, for example, a processing device may determine, select, and/or output one or more underwriting questions (one or more of which may be specific to the determined classification of the customer's business). According to some embodiments, answers to the underwriting questions received from a user device (and/or via an interface) may be utilized to determine customer eligibility for a selected policy (and/or product). Certain answers to underwriting questions may disqualify a customer with respect to one or more policy and/or product types, for example, and/or may qualify the customer for certain policies, products, and/or different tiers thereof. In some embodiments, answers to underwriting questions may trigger a determination of whether reclassification is required and/or desired, at 312. In the case that the classification 308 is controlled by the customer or underwriter (e.g., manually selected, searched, or provided), for example, the classification 308 may not be accurate. In such embodiments, an underwriting question may be configured to explore distinctions between similar and/or related classifications and answers thereto may indicate that reclassification 312 should occur. In some embodiments, a positive determination of a need and/or desire for reclassification 312 may cause the method 300 to proceed back to classification 308. In such a manner, for example, upon determining eligibility 310 (for the second time), underwriting questions and/or eligibility concerns related to the new classification of the business may be loaded, determined, output, and/or answered.

In some embodiments, reclassification 312 may comprise routing and/or rerouting information regarding the customer, policy, product, and/or business classification to an appropriate and/or different business unit associated with an underwriter's organization. In the case that the original classification comprised a type of business for which personal insurance products are available but eligibility is determined not to exist at 310, for example, rules may be applied to determine if a different business unit such as a business insurance unit and/or company may be available to fulfill a request for the desired product(s). In such a manner, for example, a larger organization may institute stored rules and/or criteria that cause an inquiry and/or product request to be automatically routed and/or rerouted to different affiliates, departments, and/or personnel based on the classification 308 and/or reclassification 312. In some embodiments, such as in the case that eligibility is determined not to exist at 310 and reclassification is determined not to be appropriate and/or possible at 312, the method 300 may comprise a declination at 313. An inquiry and/or product request that fails eligibility at 310 may, for example, simply not be within the appetite of a particular insurer and/or other applicable business associated with the method 300. As described herein in conjunction with FIG. 5C, reasons for the declination 313 and/or suggestions or recommendations regarding what changes may be made to fall within the applicable appetite may be provided. According to some embodiments, a computerized processing device such as a PC or computer server and/or a software program and/or interface may receive the eligibility determination 310 and/or one or more indications thereof (such as any associated underwriting questions).

In some embodiments, the method 300 may comprise policy (and/or product) type selection, at 314. Based on the input and/or received customer detail entry 304 (and/or account search 302 results), for example, a software program and/or computerized processing device may look-up, search, identify, calculate, and/or otherwise determine one or more available policy types, at 314. According to some embodiments, the customer and/or underwriter may choose, select, and/or identify one or more desired policy types at 314. An interface may be utilized, for example, to select a desired policy type from a drop-down menu of available underwriting products. Such a menu of available product and/or policy types may, in some embodiments, be populated based on the determination of eligibility at 310. In some embodiments, policy type selection 314 may comprise a walk-through or “wizard” including questions configured and/or selected to assist a customer (and/or underwriter/distributor) in selecting an appropriate policy type based on desired coverage, benefits, results, etc. In some embodiments, a computerized processing device such as a PC or computer server and/or a software program and/or interface may receive the policy type selection 314 and/or one or more indications thereof.

According to some embodiments, the method 300 may comprise policy creation, at 316. Based on the policy type selection 314, customer detail entry 304, and/or account search 302, for example, an underwriting program and/or associated device and/or interface may create a policy number, session, and/or account identifier, log, and/or other record of the policy type selection 314 in reference to the customer and/or underwriter desiring to price the policy or product.

In some embodiments, the method 300 may comprise coverage selection, at 318. The customer and/or underwriter may select various available coverage levels and/or types for the policy, for example, as desired. According to some embodiments, interface options may allow various available coverage parameters to be selected and/or input. In some embodiments, a computerized processing device such as a PC or computer server and/or a software program and/or interface may receive the coverage selection 318 and/or one or more indications thereof.

The method 300 may, according to some embodiments, comprise providing a rate quote, at 320. Based on the account search 302, the customer detail entry 304, the policy type selected at 314, the location entry 306, the classification 308 (and/or reclassification 312), the eligibility determination 310, and/or the coverage selected at 318, for example, the underwriter and/or distributor may provide to the customer (and/or the customer may otherwise receive) a quote for one or more underwriting products (e.g., in accordance with the policy type selection 314). In some embodiments, the underwriter may provide a quote for any number of underwriting products such as a quote for each of a plurality of insurance product types and/or tiers. According to some embodiments, the underwriter may determine, define, generate, and/or otherwise identify the quote. The quote may then, for example, be provided, transmitted, displayed, and/or otherwise output to the customer via any methodology that is or becomes desirable or practicable. The quote provided by the underwriting entity may comprise one or more of the following: premium/price (which may include a high-risk price and/or a low-risk price), insurance and/or surety capacity (e.g., an aggregate line of credit), collateral requirements, indemnity requirements, international bond restrictions, surety product type restrictions, other risk restrictions/exclusions, and/or financial reporting requirements. According to some embodiments, a computerized processing device such as a PC or computer server and/or a software program and/or interface may receive the rate quote 320 and/or one or more indications thereof.

In some embodiments, the method 300 may comprise a product sale, at 322. An underwriter, customer service representative, distributor, and/or sales agent (who may be the same as or different from the underwriter), for example, may receive an indication that the customer desires to purchase an underwriting product based on the rate quote provided at 320. The necessary paperwork and financial arrangements to consummate the sale of the underwriting product may be put in place, according to some embodiments, thus effectuating the sale of the underwriting product to the customer. In some embodiments, the sale may include post-sale activities such as receipt of premiums and revision and/or renewal of underwriting product terms or parameters. In some embodiments, the customer may initiate and/or conduct the product sale 322, such as in a self-service manner via a website.

According to some embodiments, the method 300 may comprise a loss event, at 324. In the event that the customer defaults on an obligation which is the subject of the underwriting product purchased at 322, a loss event 324 may occur. The underwriting business may be required to pay a settlement to a beneficiary of a surety product and may be unable, for example, to recoup reimbursement for the full settlement amount from the customer (even if full reimbursement is possible, the necessity of conducting processes in response to the default may cause losses that may not be reimbursable—e.g., attorneys fees, staff salaries, and/or other administrative overhead or costs). Similarly, a payout on an insurance loss may occur in relation to the loss event 324.

The method 300 may, in some embodiments, comprise a rate calculation update, at 326. Information associated with the loss event 324, for example, may be utilized to update formulas and/or calculations that are utilized to determine rate quotes 320. In some embodiments, the method 300 may comprise a classification rules update, at 328. Information associated with the loss event 324, for example, may be utilized to update rules utilized to achieve and/or conduct the classification 308. Such feedback loops may, in some embodiments, promote increased accuracy of product underwriting guidance (e.g., business classifications) and/or promote increased efficiency and/or profits associated with product underwriting and/or sales.

Turning now to FIG. 4A, FIG. 4B, FIG. 4C, FIG. 4D, and FIG. 4E, an example interface 410 according to some embodiments is shown. In some embodiments, the interface 410 may comprise a web page, web form, database entry form, API, spreadsheet, table, and/or application or other GUI via which an underwriter (or customer or other entity) may enter data to conduct and/or facilitate an underwriting and/or sales process. The interface 410 may, for example, comprise a front-end of an underwriting program and/or platform programmed and/or otherwise configured to execute, conduct, and/or facilitate any of the various methods 300, 308a, 600 of FIG. 3A, FIG. 3B, and/or FIG. 6 and/or portions or combinations thereof described herein. In some embodiments, the interface 410 may be output via a computerized device such as one or more of the user devices 102a-n, 202 and/or the controller device 104 or the classification device 204, of FIG. 1 and/or FIG. 2 herein.

According to some embodiments, and referring specifically to FIG. 4A, the interface 410 may comprise one or more tabs and/or other segmented and/or logical-presented data forms and/or fields. In some embodiments, the interface 410 may be configured and/or organized to allow and/or facilitate entry of general information regarding a customer account (and/or potential customer account). As depicted, for example, an area (e.g., one or more data entry mechanisms, tools, objects, and/or features) may be provided such that policy data 420 descriptive of an account, policy, and/or product may be entered. The policy data 420 may comprise, for example, a policy number field 422 and/or a governing state field 424. In some embodiments, the policy number field 422 may comprise an alphanumeric and/or unique identifier of a particular policy created (and/or quoted) for a customer and/or by an underwriter. The policy number field 422 may, for example, be automatically populated by an underwriting system such as during policy creation 316 in the method 300 of FIG. 3A. According to some embodiments, the governing state field 424 may be populated based on location information regarding the customer and/or the customer's business.

In some embodiments, the interface 410 may comprise one or more areas (e.g., one or more data entry mechanisms, tools, objects, and/or features) via which insured data 430 descriptive of descriptive of a customer (e.g., an insured) may be entered. The insured data 430 may comprise, for example, one or more insured identifier fields 432, one or more insured location fields 434, and/or one or more underwriting question fields 436. The insured identifier fields 432 may, according to some embodiments, comprise any type, quantity, and/or configuration of data fields regarding an identity of the customer/insured/business. The insured identifier fields 432 may, as depicted for example, comprise information descriptive of a legal entity type and/or name of the insured. According to some embodiments, the insured identifier fields 432 may be populated with information received from the customer (and/or input by an underwriter) such as via the account search 302 and/or customer detail entry 304 of the method 300 of FIG. 3A.

According to some embodiments, the insured location fields 434 may comprise any type, quantity, and/or configuration of data fields regarding a location of the customer/insured/business. The insured location fields 434 may, as depicted for example, comprise information descriptive of an address and/or address type (e.g., billing, mailing, etc.) of the insured. According to some embodiments, the insured location fields 434 may be populated with information received from the customer (and/or input by an underwriter) such as via the location entry 306 of the method 300 of FIG. 3A. According to some embodiments, one or more of the insured location fields 434 may be populated automatically and/or utilizing current location information of a user device.

In some embodiments, the underwriting question fields 436 may comprise any type, quantity, and/or configuration of data fields regarding underwriting questions, rules, parameters, and/or guidelines. The underwriting question fields 436 may, as depicted for example, comprise information descriptive of questions configured to obtain information directed to the business type of the insured. A first example underwriting question 436-1 may, as shown for example, ask whether the business conducts off-site repairs. According to some embodiments, the underwriting question fields 436 may be populated with questions received and/or retrieved from a database (such as the enterprise database 240a of FIG. 2) and/or with answers provided by the customer (and/or input by an underwriter) such as during the eligibility determination 310 of the method 300 of FIG. 3A and/or associated with providing questions to the user at 308a-6 of FIG. 3B. According to some embodiments, the underwriting question fields 436 may be populated based on information regarding the insured.

In some embodiments, for example, the insured data 430 may comprise a primary business classification field 440 and/or a business classification search button 442. According to some embodiments, the underwriting question fields 436 may be populated based on the business classification field 440. The business classification field 440 may, according to some embodiments, by automatically populated (and/or pre-populated), such as based on the insured identifier fields 432 and/or the insured location fields 434. As described in accordance with embodiments herein, for example, the interface 410 may determine and/or output the determined business classification field 440 (e.g., on behalf of the user, customer, and/or underwriter). The business classification field 440 may be populated, in some embodiments, via the classification 308 of the method 300 of FIG. 3A and/or via the method 308a of FIG. 3B. In some embodiments, such as in the case that the customer and/or underwriter desires to change the business classification field 440 (and/or in the case that a pre-population of the business classification field 440 was unsuccessful), the business classification search button 442 may be activated and/or utilized.

According to some embodiments, and turning specifically to FIG. 4B for example, the interface 410 may comprise a business classification search window 444. The business classification search window 444 may, in some embodiments, be called, initiated, and/or output upon activation of the business classification search button 442 of FIG. 4A. According to some embodiments, the business classification search window 444 may comprise one or more search options 444-1. The search options 444-1 may include, but are not limited to, a keyword search, a segment search, a SIC code search, a NAICS code search, and/or a program code search (all as depicted in FIG. 4B). In the example interface 410 of FIG. 4B, the customer and/or underwriter has selected the NAICS search option.

In some embodiments, the business classification search window 444 may comprise a search option input area 444-2. As depicted in the example of FIG. 4B, the search option input area 444-2 may comprise various fields configured to allow the user to input data such as search terms in accordance with the selected one (or more) of the search options 444-1 (in the example shown, a NAICS search). In some embodiments, the business classification search window 444 may comprise a business classification field 444-3. The business classification field 444-3 may be utilized, for example, to allow a user to search for specified terms (e.g., a NAICS code in the example shown) within one or more specific business classifications and/or segments. In some embodiments (not explicitly shown), the business classification field 444-3 may provide a listing and/or cross-reference of various proprietary business classifications (e.g., business classification types utilized by different insurance and/or underwriting companies).

According to some embodiments, and turning specifically to FIG. 4C, the interface 410 may comprise an eligibility window 450. The eligibility window 450 may, in some embodiments, be called, initiated, and/or output upon selection and/or determination of a business classification. According to some embodiments, the eligibility window 450 may be output upon completion of one or more of the underwriting question fields 436 (from FIG. 4A). In some embodiments, the eligibility window 450 may comprise one or more eligibility guidelines 450-1 descriptive of criteria for eligibility (e.g., based on the selected business class and/or other data) and/or one or more criteria verification toggles 450-2. In some embodiments, the criteria verification toggles 450-2 may be utilized to receive input from the user verifying that any eligibility criteria associated with the one or more eligibility guidelines 450-1, are indeed satisfied. According to some embodiments, the eligibility window 450 may be provided as part of the eligibility determination 310 of the method 300 of FIG. 3A.

In some embodiments, and turning specifically to FIG. 4D, the interface 410 may be configured and/or organized to allow and/or facilitate entry of general information regarding location and/or building details associated with a customer account (and/or potential customer account). As depicted, for example, an area (e.g., one or more data entry mechanisms, tools, objects, and/or features) may be provided such that location data 460, coverage information 470, and/or premises data 480, descriptive of an account, policy, and/or product may be entered. The location data 460 may comprise, for example, one or more data fields descriptive of the location of the business and/or how business operations are conducted at the location. According to some embodiments, the coverage information 470 may comprise one or more fields descriptive of an amount, type, and/or configuration of coverage desired under the policy. The coverage information 470 may be received, determined, and/or populated, for example, during the coverage selection 318 of the method 300 of FIG. 3A. In some embodiments, the premises data 480 may comprise one or more fields descriptive of a building and/or structure at the location.

According to some embodiments, and turning specifically to FIG. 4E, the interface 410 may be configured and/or organized to facilitate policy and/or product review and/or reclassification. As depicted, for example, the insured location fields 434 from FIG. 4A (and/or data thereof) may be output, such as for review and/or confirmation. In some embodiments, a new business classification 446 and/or an updated business segment 448 may be provided. The new business classification 446 may be determined, for example, by the reclassification 312 of the method 300 of FIG. 3A and/or the method 308a of FIG. 3B. One or more of the underwriting question fields 436 of FIG. 4A and/or the one or more eligibility guidelines 450-1 of FIG. 4C (and/or answers associated therewith) may, for example, trigger a reclassification of the business. In some embodiments, common and/or likely errors in classification may be probed utilizing specially configured questions designed to trigger reclassification upon identification of such errors. In the example depicted in the interface 410, for example, while the initial classification of the business (e.g., as stored in and/or output via the business classification field 440 of FIG. 4A) was an “appliance store” or “store”, a trigger, such as the depicted positive answer to the first example underwriting question 436-1 of FIG. 4A may have caused a reclassification to “contractor”, shown in the updated business segment 448. Off-site repairs, for example, may be more descriptive of a “plumbing contractor”, as depicted by the new business classification 446. In some embodiments, such as in the case that the interface 410 is output by an underwriting program or application not affiliated with any specific insurance carrier and/or underwriting product provider, the initial business classification of the business classification field 440 and/or the new business classification 446 may be set, selected, and/or based on rules for specific carriers and/or providers, based on the preferences and/or selections of the user.

While the example interface 410 is depicted herein with respect to a specific example of an insurance product policy underwriting process, other products, classifications, classification searches, and/or reclassifications may be provided in accordance with some embodiments. While the depicted classification comprises a business classification, for example, classification of other underwriting metrics may also or alternatively be utilized by and/or incorporated into the interface 410.

Turning now to FIG. 5A, FIG. 5B, and FIG. 5C, an exemplary interface 510 according to some embodiments is shown. In some embodiments, the interface 510 may comprise a web page, web form, database entry form, API, spreadsheet, table, and/or application or other GUI via which an underwriter (or other entity) may enter data to conduct and/or facilitate an underwriting and/or sales process. The interface 510 may, for example, comprise a front-end of an underwriting program and/or platform programmed and/or otherwise configured to execute, conduct, and/or facilitate any of the various methods 300, 308a, 600 of FIG. 3A, FIG. 3B, and/or FIG. 6 and/or portions or combinations thereof described herein. In some embodiments, the interface 510 may be output via a computerized device such as one or more of the user devices 102a-n, 202 and/or the controller device 104 or the smart classification device 204, of FIG. 1 and/or FIG. 2 herein. According to some embodiments, the interface 510 may be similar in configuration and/or functionality to the interface 410 described in conjunction with FIG. 4 herein. Components of the interface 510 may, for example, be similar in configuration and/or functionality to any similarly-named and/or numbered components of the interface 410.

According to some embodiments, and turning specifically to FIG. 5A for example, the interface 510 may comprise a business classification search window 544. The business classification search window 544 may, in some embodiments, be activated at the request and/or command of a user (such as a customer and/or underwriter) and/or may be activated or output such as in the case that an automatic (and/or pre-determined) business classification cannot be obtained. According to some embodiments, the business classification search window 544 may comprise one or more search options 544-1. The search options 544-1 may include, but are not limited to, a keyword search, a segment search, a SIC code search, a NAICS code search, and/or a program code search (all as depicted in FIG. 5A). In the example interface 510 of FIG. 5A, the customer and/or underwriter has selected the “keyword” search option.

In some embodiments, the business classification search window 544 may comprise a search option input area 544-2. As depicted in the example of FIG. 5A, the search option input area 544-2 may comprise various fields configured to allow the user to input data such as keyword search terms in accordance with the selected one (or more) of the search options 544-1 (in the example shown, a keyword search). In some embodiments, the business classification search window 544 may comprise a business classification field 544-3. The business classification field 544-3 may be utilized, for example, to allow a user to search for specified terms (e.g., a keyword of “pet” in the example shown) within one or more specific business classifications and/or segments. In some embodiments (not explicitly shown), the business classification field 544-3 may provide a listing and/or cross-reference of various proprietary business classifications (e.g., business classification types utilized by different insurance and/or underwriting companies).

According to some embodiments, and referring specifically to FIG. 5B, the interface 510 may comprise one or more tabs and/or other segmented and/or logical-presented data forms and/or fields. In some embodiments, the interface 510 may be configured and/or organized to allow and/or facilitate entry of location information regarding a customer account (and/or potential customer account). As depicted, for example, an area (e.g., one or more data entry mechanisms, tools, objects, and/or features) may be provided such that location data 534 descriptive of one or more locations associated with an account, policy, and/or product may be entered. According to some embodiments, the location data 534 may comprise any type, quantity, and/or configuration of data fields regarding a location of the customer/insured/business. The location data 534 may, as depicted for example, comprise information descriptive of an address and/or address type (e.g., billing, mailing, etc.) of the insured. According to some embodiments, the location data 534 may be populated with information received from the customer (and/or input by an underwriter) such as via the location entry 306 of the method 300 of FIG. 3A. According to some embodiments, the location data 534 may be populated automatically and/or utilizing current location information of a user device.

In some embodiments, the interface 510 may be configured and/or organized to allow and/or facilitate entry and/or output of underwriting information regarding a customer account (and/or potential customer account). As depicted, for example, an area (e.g., one or more data entry mechanisms, tools, objects, and/or features) may be provided such that underwriting questions 536 related to the account, product, policy, and/or customer may be provided (and/or via which the underwriting questions 536 may be answered). In some embodiments, the underwriting questions 536 may comprise any type, quantity, and/or configuration of data fields regarding underwriting questions, rules, parameters, and/or guidelines. The underwriting questions 536 may, as depicted for example, comprise information descriptive of questions configured to obtain information directed to the business type of the insured. According to some embodiments, the underwriting questions 536 may be populated with questions received and/or retrieved from a database (such as the enterprise database 240a of FIG. 2) and/or with answers provided by the customer (and/or input by an underwriter) such as during the eligibility determination 310 of the method 300 of FIG. 3A. According to some embodiments, the underwriting questions 536 may be populated based on information regarding the insured. According to some embodiments, different types and/or categories of underwriting questions 536 may be provided, such as store underwriting questions 536-1 and/or premises underwriting questions 536-2, as shown in FIG. 5B. The different underwriting questions 536-1, 536-2 may, for example, be provided, initiated, determined, and/or output based on information regarding specific policy attributes such as whether the policy and/or customer is associated with operation of a “store” and/or activities undertaken by the customer at the “premises”.

According to some embodiments, the interface 510 may be configured and/or organized to allow and/or facilitate entry and/or output of classification information regarding a customer account (and/or potential customer account). As depicted, for example, an area (e.g., one or more data entry mechanisms, tools, objects, and/or features) may be provided such that business classification data 540 related to the account, product, policy, and/or customer may be provided. In some embodiments, the business classification data 540 may comprise any type, quantity, and/or configuration of data fields regarding business and/or other underwriting parameter classifications, categorizations, rankings, sorting, filtering, etc. In some embodiments, for example, the business classification data 540 may comprise a primary business classification field 540-1 and/or a business classification search button 542.

According to some embodiments, the underwriting questions 536 may be populated based on the primary business classification field 540-1. The primary business classification field 540-1 may, according to some embodiments, by populated based on a keyword search conducted by a user (such as the example “pet” keyword search depicted in the business classification search window 544 of FIG. 5A). The primary business classification field 540-1 may be populated, in some embodiments, via the classification 308 of the method 300 of FIG. 3A and/or the method 308a of FIG. 3B. In some embodiments, such as in the case that the customer and/or underwriter desires to change the primary business classification field 540-1 (and/or in the case that any pre-population of the primary business classification field 540-1 was unsuccessful or not desired), the business classification search button 542 may be activated and/or utilized (e.g., to initiate the business classification search window 544 of FIG. 5A).

In some embodiments, eligibility criteria (e.g., based on the value of the primary business classification field 540-1) may be reviewed and/or edited via an eligibility button 550. Once the primary business classification field 540-1 has been determined (e.g., selected by a user keyword search in the present example), for example, the eligibility button 550 may become available via the interface 510 and/or a separate eligibility screen or window (not shown in FIG. 5B) may be launched or output. According to some embodiments, the interface 510 may comprise an area where policy coverage data 570 may be stored, edited, and/or output. In some embodiments, the policy coverage data 570 and/or associated fields or values may be based on the business classification data 540, the underwriting questions 536 (and/or answers thereto), and/or any satisfied and/or unsatisfied eligibility criteria (such as may be linked to the eligibility button 550).

According to some embodiments, and turning specifically to FIG. 5C for example, the interface 510 may comprise declination reasons 590. In the case that answers to the underwriting questions 536 of FIG. 5B indicate that the desired policy/product falls outside of current business appetite, for example, the declination reasons 590 may provide insight into what parameters would need to be changed to bring the desired policy/product (and/or customer or business) within acceptable ranges for underwriting purposes. In some embodiments, declination may comprise, instead of simply rejecting a potential policy and/or customer, routing and/or rerouting the request to a different business unit, department, etc., as described herein.

While various components of the interfaces 410, 510 of FIG. 4A, FIG. 4B, FIG. 4C, FIG. 4D, FIG. 4E, FIG. 5A, FIG. 5B, and FIG. 5C have been described with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Referring now to FIG. 6, a flow diagram of a method 600 according to some embodiments is shown. In some embodiments, the method 600 may be performed and/or implemented by and/or otherwise associated with one or more specialized computerized processing devices (e.g., the user devices 102a-n, 202 and/or the controller device 104 or the smart classification device 204, of FIG. 1 and/or FIG. 2 herein), specialized computers, computer terminals, computer servers, computer systems and/or networks, and/or any combinations thereof (e.g., by one or more insurance company and/or surety underwriter computers). In some embodiments, the method 600 may be related to and/or comprise a portion of an underwriting process or method such as the methods 300, 308a of FIG. 3A and/or FIG. 3B herein. In some embodiments, the method 600 may be embodied in, facilitated by, and/or otherwise associated with various input mechanisms and/or interfaces such as the example interfaces 410, 510 described with respect to FIG. 4A, FIG. 4B, FIG. 4C, FIG. 4D, FIG. 4E, FIG. 5A, FIG. 5B, and/or FIG. 5C herein.

According to some embodiments, the method 600 may comprise receiving (e.g., by a specially-programmed computerized processing device and/or from a user device) an indication of identifying information of a business for which an underwriting product is sought, at 602. Input from a user such as a customer (e.g., a potential customer) and/or an underwriter or customer service representative may, for example, be indicative of identifying information such as a name and/or a location associated with a desired underwriting policy and/or product. In some embodiments, the information may comprise a postal code, address, telephone number, e-mail address or domain (e.g., for “virtual” locations), and/or coordinates and/or other geospatial data. In some embodiments, name and/or location information of a customer may be obtained from an existing policy and/or based on a search or query utilizing identifying information of the customer (e.g., the customer's business name). In some embodiments, the identifying information may be pushed by a user device such as a mobile telephone, PDA, and/or tablet computer and/or may be pulled from such devices, as is or becomes desired or practicable.

According to some embodiments, the method 600 may comprise determining (e.g., by a specially-programmed computerized processing device), based on third-party data, a business classification of the business, at 604. The identifying information (e.g., name and/or location information) may be utilized to query one or more databases (such as the enterprises database 240a of FIG. 2), for example, to determine if a business classification for the business is already known and/or stored. In some embodiments, the identifying information (or a portion thereof) may be passed to a third-party such as an information services company. The third-party may return and/or provide (e.g., in response to a query and/or request based on the identifying information), and/or an underwriting device may receive, an indication of a business classification of the business. In some embodiments, the returned information may comprise a credibility factor which may be utilized, for example, to determine a likelihood of accuracy of the business classification. In some embodiments, only returned business classification information of certain credibility levels (e.g., only credibility factors of eight (8) or higher on a scale of one (1) to ten (10)) may be utilized and/or passed on to the user. In some embodiments, multiple third-party databases and/or services may be utilized to determine a business classification based on the location information. As described herein, while business classification determination based on a business's identifying information is provided as one example of embodiments herein, other underwriting metrics may also or alternatively be determined based on such identifying information.

In some embodiments, the method 600 may comprise providing (e.g., by a specially-programmed computerized processing device and/or to a user device) an indication of the determined business classification of the business, at 606. An interface (such as the interfaces 210, 410, 510 of FIG. 2, FIG. 4A, FIG. 4B, FIG. 4C, FIG. 4D, FIG. 4E, FIG. 5A, FIG. 5B, and/or FIG. 5C) may be provided, for example, via which the determined business classification information may be provided to a customer, underwriter, and/or other user. In some embodiments, the business classification may be provided automatically upon acquisition of the identifying information. In some embodiments, the provided business classification information may comprise a default and/or suggested business classification. A user may, according to some embodiments, override the provided business classification and/or search for and/or select a different business classification.

In some embodiments, the indication at 606 may comprise an indication of an appropriate business unit, company, department, and/or personnel applicable to the business (e.g., based on the business classification). The indication at 606 may comprise, for example, intra-company and/or inter-company routing information and/or may comprise an actual routing and/or rerouting of information (e.g., to one or more business units determined to be applicable to the business and/or other classification). In such a manner, for example, an inquiry and/or request for an underwriting and/or insurance product may be quickly and/or automatically routed (and/or rerouted) to one or more specific destinations and/or entities. An insurance product inquiry for a specific business that is classified (e.g., at 604) may, for example, classify the business such that products are known to be available (e.g., within a business appetite) for both a Construction Services business unit and a Public Company Liability business unit of an insurer. The Public Company Liability business unit may be capable of writing/pricing/selling a Directors and Officers Liability policy for the business, for example, while the Construction Services business unit may be capable of writing/pricing/selling a Crime (e.g., disappearance and/or destruction of property) policy. In some embodiments, such routing may be based on and/or include industry codes such as the SIC and/or NAICS codes described herein.

According to some embodiments, the method 600 may comprise providing (e.g., by a specially-programmed computerized processing device and/or to a user device) an indication of at least one underwriting question that is based on the business classification of the business, at 608. In some embodiments, underwriting questions may be determined based on the business classification (e.g., the business classification provided automatically based on the location information, at 606, and/or a user-selected business classification). In some embodiments, known or expected business classification errors, such as improper selection of one business type instead of a similar business type, may be addressed by presentation of underwriting questions configured to acquire response data that may be utilized to identify which of the similar business classifications is most appropriate. In some embodiments, the underwriting questions may comprise questions based on any combination of policy/product data, customer data, location data, and/or business (or other) classification data.

The method 600 may, in some embodiments, comprise receiving (e.g., by a specially-programmed computerized processing device and/or from a user device in response to the providing of the at least one underwriting question that is based on the business classification of the business) an indication of an answer to the at least one underwriting question that is based on the business classification of the business, at 610. Input from a user may, for example, be captured by an interface of an underwriting program in accordance with embodiments described herein. In some embodiments, answers to underwriting questions may be determined automatically and/or form fields may be pre-populated based on information regarding the desired policy and/or policy holder. In some embodiments, underwriting question answers may be derived from other underwriting question answers.

According to some embodiments, the method 600 may comprise determining (e.g., by a specially-programmed computerized processing device), based on the answer to the at least one underwriting question that is based on the business classification of the business, a new business classification of the business, at 612. The original business classification may, for example, be determined to be inaccurate based on how one or more of the underwriting questions have been answered. The difference between two or more business classifications may, for example, be at least partially determined based on one or more specific activities, attributes, and/or qualities of the customer, the customer's business (e.g., the nature of the business and/or business operations, scale, size, and/or frequency), and/or a location of the customer and/or customer's business.

The method 600 may, in some embodiments, comprise providing (e.g., by a specially-programmed computerized processing device and/or to a user device) an indication of the new business classification of the business, at 614. The user may be notified of the reclassification, for example, and/or provided with details regarding why the reclassification occurred. In such a manner, for example, the user may become more familiar with the differences and/or distinctions between various business classifications.

The method 600 and the various procedures and/or steps described in reference thereto are intended to be exemplary in nature. Fewer or more procedures, steps, decisions, flow diagram elements, and/or components may be included in the method 600 as is or becomes desirable and/or practicable. The order of any procedures, steps, and/or flow diagram elements of the method 600 is also exemplary in nature. Procedures, steps, and/or elements may be deleted, excluded, and/or removed from the method 600 and/or may not be active or practiced in every occurrence and/or implementation of the method 600.

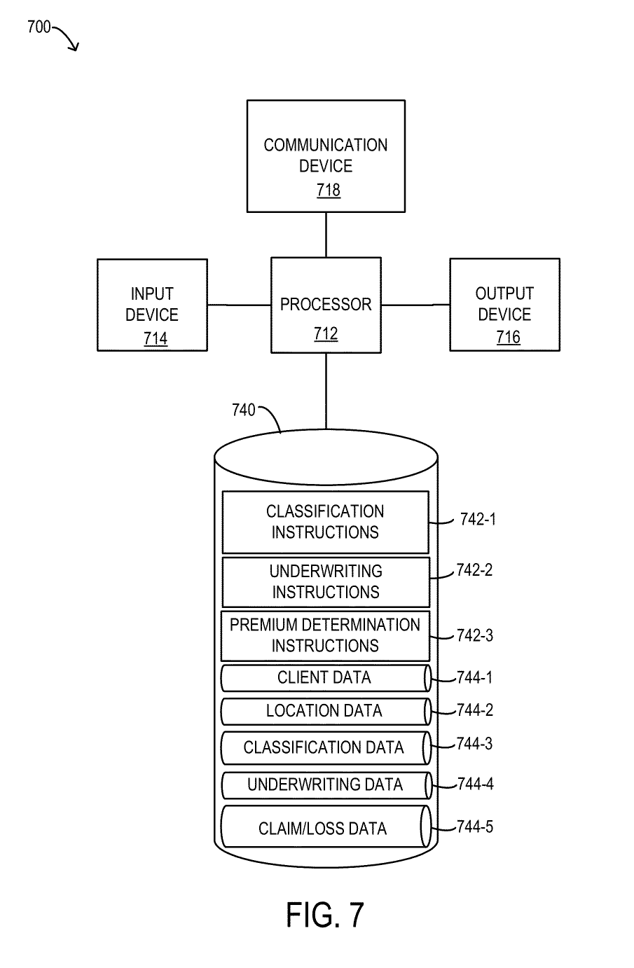

Turning to FIG. 7, a block diagram of an apparatus 700 according to some embodiments is shown. In some embodiments, the apparatus 700 may be similar in configuration and/or functionality to user devices 102a-n, 202 and/or the controller device 104 or the classification device 204, of FIG. 1 and/or FIG. 2 herein. The apparatus 700 may, for example, execute, process, facilitate, and/or otherwise be associated with the methods 300, 308a, 600 of FIG. 3A, FIG. 3B, and/or FIG. 6, and/or may output or provide the interfaces 210, 410, 510 of FIG. 2, FIG. 4A, FIG. 4B, FIG. 4C, FIG. 4D, FIG. 4E, FIG. 5A, FIG. 5B, and FIG. 5C herein. In some embodiments, the apparatus 700 may comprise an electronic processor 712, an input device 714, an output device 716, a communication device 718, and/or a memory device 740. Fewer or more components 712, 714, 716, 718, 740 and/or various configurations of the components 712, 714, 716, 718, 740 may be included in the system 700 without deviating from the scope of embodiments described herein.

According to some embodiments, the electronic processor 712 may be or include any type, quantity, and/or configuration of electronic and/or computerized processor that is or becomes known. The electronic processor 712 may comprise, for example, an Intel® IXP 2800 network processor or an Intel® XEON™ Processor coupled with an Intel® E7501 chipset. In some embodiments, the electronic processor 712 may comprise multiple inter-connected processors, microprocessors, and/or micro-engines. According to some embodiments, the electronic processor 712 (and/or the apparatus 700 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 700 comprises a server such as a blade server, necessary power may be supplied via a standard AC outlet, power strip, surge protector, and/or Uninterruptible Power Supply (UPS) device.

In some embodiments, the input device 714 and/or the output device 716 are communicatively coupled to the electronic processor 712 (e.g., via wired and/or wireless connections, traces, and/or pathways) and they may generally comprise any types or configurations of input and output components and/or devices that are or become known, respectively. The input device 714 may comprise, for example, a keyboard that allows an operator of the apparatus 700 to interface with the apparatus 700 (e.g., an underwriter, such as to implement and/or interact with embodiments herein to underwrite, quote, and/or sell underwriting products). The output device 716 may, according to some embodiments, comprise a display screen and/or other practicable output component and/or device. The output device 716 may, for example, provide surety product underwriting guidance, benchmarks, and/or quotes (e.g., via a website and/or via a computer workstation). According to some embodiments, the input device 714 and/or the output device 716 may comprise and/or be embodied in a single device such as a touch-screen monitor.

In some embodiments, the communication device 718 may comprise any type or configuration of communication device that is or becomes known or practicable. The communication device 718 may, for example, comprise a Network Interface Card (NIC), a telephonic device, a cellular network device, a router, a hub, a modem, and/or a communications port or cable. In some embodiments, the communication device 718 may be coupled to provide data to a customer device, such as in the case that the apparatus 700 is utilized to provide underwriting product quotations and/or sales. According to some embodiments, the communication device 718 may also or alternatively be coupled to the electronic processor 712. In some embodiments, the communication device 718 may comprise an IR, RF, Bluetooth™, and/or Wi-Fi® network device coupled to facilitate communications between the electronic processor 712 and another device (such as a customer device and/or a third-party device).

The memory device 740 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 740 may, according to some embodiments, store one or more of classification instructions 742-1, underwriting instructions 742-2, and/or premium determination instructions 742-3. In some embodiments, the classification instructions 742-1, underwriting instructions 742-2, and/or premium determination instructions 742-3 may be utilized by the electronic processor 712 to provide output information via the output device 716 and/or the communication device 718 (e.g., the providing of the business classification at 606, the providing of the underwriting questions at 608, and/or the providing of the business class reclassification at 614, of the method 600 of FIG. 6).

According to some embodiments, the classification instructions 742-1 may be operable to cause the electronic processor 712 to access the client data 744-1, location data 744-2, classification data 744-3, underwriting data 744-4, and/or claim/loss data 744-5, as described herein (e.g., in accordance with the methods 300, 308a, 600 of FIG. 3A, FIG. 3B, and/or FIG. 6 herein). Client data 744-1, location data 744-2, and/or claim/loss data 744-5 received via the input device 714 and/or the communication device 718 may, for example, be analyzed, sorted, filtered, decoded, decompressed, ranked, scored, plotted, and/or otherwise processed by the electronic processor 712 in accordance with the classification instructions 742-1. In some embodiments, client data 744-1, location data 744-2, classification data 744-3, underwriting data 744-4, and/or claim/loss data 744-5 may be fed by the electronic processor 712 through one or more mathematical and/or statistical formulas, rule sets, policies, and/or models in accordance with the classification instructions 742-1 to determine one or more business (and/or other) classifications (and/or reclassifications) that may then be utilized to facilitate product underwriting as described herein.

According to some embodiments, the underwriting instructions 742-2 may be operable to cause the electronic processor 712 to access the client data 744-1, location data 744-2, classification data 744-3, underwriting data 744-4, and/or claim/loss data 744-5, as described herein (e.g., in accordance with the methods 300, 308a, 600 of FIG. 3A, FIG. 3B, and/or FIG. 6 herein). Client data 744-1, location data 744-2, and/or claim/loss data 744-5 received via the input device 714 and/or the communication device 718 may, for example, be analyzed, sorted, filtered, decoded, decompressed, ranked, scored, plotted, and/or otherwise processed by the electronic processor 712 in accordance with the underwriting instructions 742-2. In some embodiments, client data 744-1, location data 744-2, classification data 744-3, underwriting data 744-4, and/or claim/loss data 744-5 may be fed by the electronic processor 712 through one or more mathematical and/or statistical formulas, rule sets, policies, and/or models in accordance with the underwriting instructions 742-2 to determine one or more underwriting questions, criteria, and/or requirements that may then be utilized to facilitate product underwriting as described herein.

According to some embodiments, the premium determination instructions 742-3 may be operable to cause the electronic processor 712 to access the client data 744-1, location data 744-2, classification data 744-3, underwriting data 744-4, and/or claim/loss data 744-5, as described herein (e.g., in accordance with the methods 300, 308a, 600 of FIG. 3A, FIG. 3B, and/or FIG. 6 herein). Client data 744-1, location data 744-2, and/or claim/loss data 744-5 received via the input device 714 and/or the communication device 718 may, for example, be analyzed, sorted, filtered, decoded, decompressed, ranked, scored, plotted, and/or otherwise processed by the electronic processor 712 in accordance with the premium determination instructions 742-3 In some embodiments, client data 744-1, location data 744-2, classification data 744-3, underwriting data 744-4, and/or claim/loss data 744-5 may be fed by the electronic processor 712 through one or more mathematical and/or statistical formulas, rule sets, policies, and/or models in accordance with the premium determination instructions 742-3 to determine a rate quote (e.g., at 320 of the method 300 of FIG. 3A) that may then be utilized to facilitate product underwriting and/or sales as described herein.

In some embodiments, the memory device 740 may store the claim/loss data 744-5. The claim/loss data 744-5 may, for example, comprise data obtained from determining loss information (e.g., at 324 of the method 300 of FIG. 3A herein) such as may be based on one or more loss and/or default events associated with a customer and/or product. The claim/loss data 744-5 may, according to some embodiments, be utilized to update, modify, and/or otherwise influence or affect the various calculations and/or processes described herein. The input device 714 and/or the communication device 718 may receive the claim/loss data 744-5, which may be stored (as depicted in FIG. 7) by the memory device 740 and/or which may be processed by the electronic processor 712 in accordance with stored instructions (not explicitly shown in FIG. 7), such as to modify one or more of the classification instructions 742-1, the underwriting instructions 742-2, and/or the premium determination instructions 742-3.

According to some embodiments, the apparatus 700 may generally function as a computer terminal and/or server of an insurance and/or surety underwriting company, for example, which is utilized to process various insurance, surety, and/or other underwriting product applications. In some embodiments, the apparatus 700 may comprise a web server and/or other portal (e.g., an IVRU) that provides underwriting and/or product pricing information to customers and/or third-parties.

Any or all of the exemplary instructions and data types described herein and other practicable types of data may be stored in any number, type, and/or configuration of memory devices that is or becomes known. The memory device 740 may, for example, comprise one or more data tables or files, databases, table spaces, registers, and/or other storage structures. In some embodiments, multiple databases and/or storage structures (and/or multiple memory devices 740) may be utilized to store information associated with the apparatus 700. According to some embodiments, the memory device 740 may be incorporated into and/or otherwise coupled to the apparatus 700 (e.g., as shown) or may simply be accessible to the apparatus 700 (e.g., externally located and/or situated).

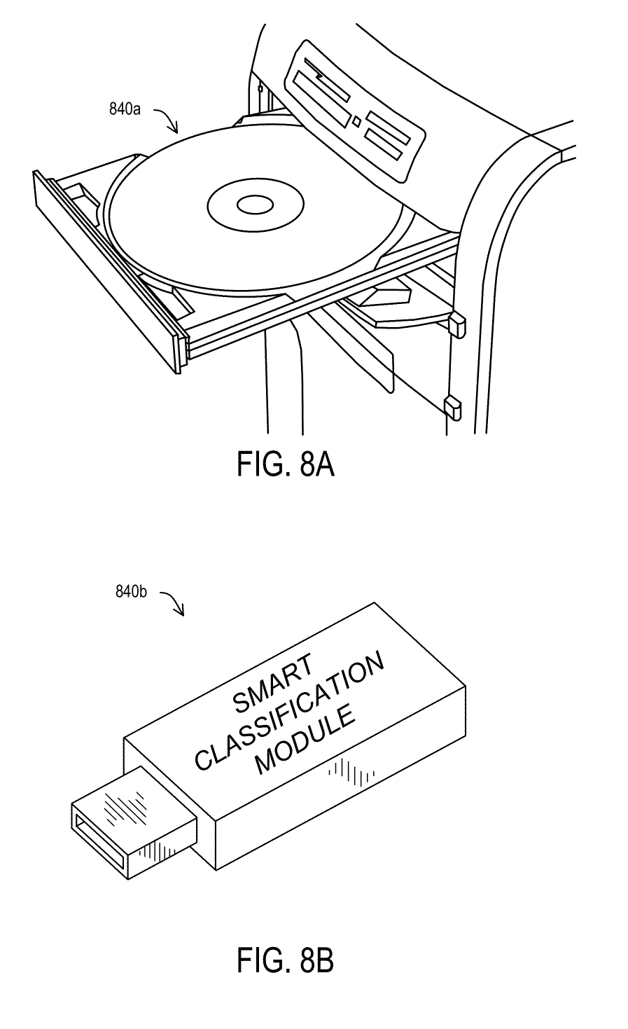

Referring to FIG. 8A and FIG. 8B, perspective diagrams of exemplary data storage devices 840a-b according to some embodiments are shown. The data storage devices 840-a-b may, for example, be utilized to store instructions and/or data such as the classification instructions 742-1, the underwriting instructions 742-2, and/or the premium determination instructions 742-3, each of which is described in reference to FIG. 7 herein. In some embodiments, instructions stored on the data storage devices 840a-b may, when executed by a processor (such as the electronic processor 712 of FIG. 7), cause the implementation of and/or facilitate any of the various methods 300, 308a, 600 of FIG. 3A, FIG. 3B, and/or FIG. 6, described herein. The data storage devices 840a-b may also or alternatively store data such as the client data 744-1, the location data 744-2, the classification data 744-3, the underwriting data 744-4, and/or the claim/loss data 744-5, all as described with reference to FIG. 7 herein.

According to some embodiments, the first data storage device 840a may comprise a CD, CD-ROM, DVD, Blu-Ray™ Disc, and/or other type of optically-encoded disk and/or other computer-readable storage medium that is or becomes know or practicable. In some embodiments, the second data storage device 840b may comprise a USB keyfob, dongle, and/or other type of flash memory data storage device that is or becomes know or practicable. The data storage devices 840a-b may generally store program instructions, code, and/or modules that, when executed by an electronic and/or computerized processing device cause a particular machine to function in accordance with embodiments described herein. In some embodiments, the data storage devices 840a-b depicted in FIG. 8A and FIG. 8B are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

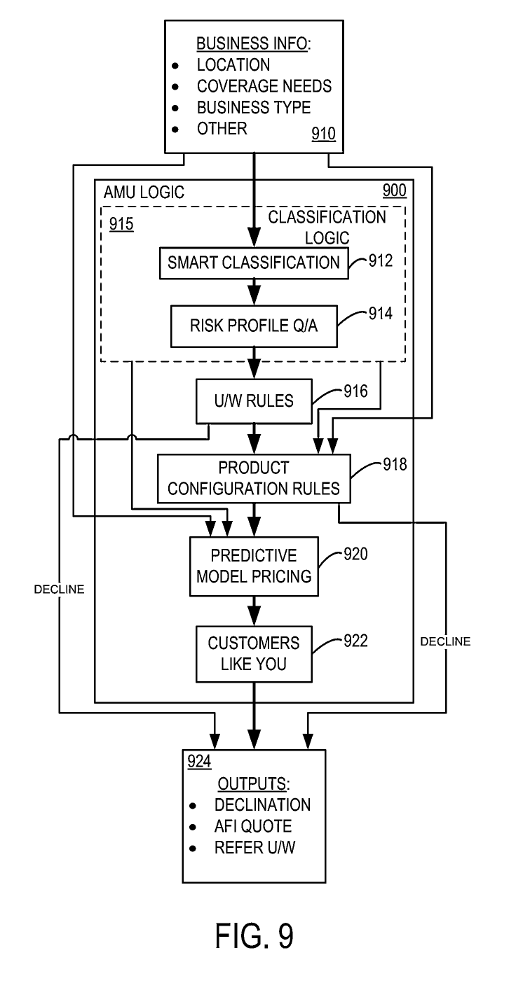

Referring to FIG. 9, in some embodiments, the present invention may be part of a larger system or logic, such as an Automated Modeled Underwriting (AMU) Logic 900. In that case, the AMU logic 900 receives inputs 910, as described herein, for Smart Classification logic 912 which works with Risk Profile logic 914 (as discussed herein), shown collectively as Classification Logic dashed box 915, to identify the proper business classification for the business being priced. The classification may then be used by Underwriting Rules Logic 916 to validate quote eligibility based on risk characteristics and product selection. A result of the Underwriting Rules Logic 916 may be that the customer is declined a quote and the AMU may cease further processing, or that the AMU continues to Product Configuration Logic 918. The Product Configuration Logic 918, may use the Business Info. 910, and results from the Classification Logic 915 and the Underwriting Logic 916 to determine the appropriate product offering for the customer (e.g., available coverages, limits, and deductibles) based on risk characteristics (e.g., geographic location of the business, business classification, legal entity, and other relevant risk characteristics). A result of the Product Configuration Logic 918 may be that the customer is declined a quote and the AMU 900 may cease further processing, or that the AMU 900 continues to Predictive Model Pricing Logic 920. Predictive Model Pricing Logic 920 may use the Business Info 910, and results from the Classification Logic 915 and the Product Configuration Logic 918, and determine the price (or rate or premium) for the desired coverage for the business by performing predictive model pricing with various risk characteristics (multivariable) to properly price each risk. Next, the AMU 900 may optionally perform Customers Like You Logic 922, which determines one or more optional insurance coverages or features for the business policy, based on several factors, such as certain coverages/features that are used by other customers in the same or similar business area or with the same or similar base insurance policy, or based on other factors, such as is described in U.S. patent application Ser. No. ______, entitled “Systems and Methods for Determining Optional Insurance Coverages,” filed Jul. 8, 2011, with attorney docket number 0137.0001, which is incorporated herein by reference to the extent necessary to understand the present disclosure. A result of the Customers Like You Logic 922 may be that the customer is declined a quote, the customer is provided with a quote which is available for issue (or AFI), or the quote is referred to an underwriter for further consideration, as indicated by output box 924. The logics 912, 914, 916, 918, 920, 922 may be performed in any desired order, and certain logics may be performed concurrently and/or continuously, throughout the AMU 900 to provide the desired functions described herein. If the Customers Like You Logic 922 is not used, the outputs 924 may come directly from the Predictive Model Pricing Logic 920, or the appropriate Logics 912-920 depending on the order performed.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
receiving, by a specially-programmed computerized processing device and from a user device, an indication of identifying information of a business for which an underwriting product is sought;
determining, by the specially-programmed computerized processing device and based on third-party data, a business classification of the business; and
determining, by the specially-programmed computerized processing device, at least one available insurance policy type based on the business classification.

2. The method of claim 1, wherein the identifying information comprises at least one of a business account attribute, a business identifier, and a business location.

3. The method of claim 1, wherein determining the business classification of the business comprises:
utilizing the identifying information, by the specially-programmed computerized processing device, to query at least one database of third-party data.

4. The method of claim 1, wherein the third-party data comprises standardized classification codes.

5. The method of claim 1, further comprising:
providing, by the specially-programmed computerized processing device and to the user device, an indication of at least one underwriting question that is based on the business classification of the business;
receiving, by the specially-programmed computerized processing device and from the user device in response to the providing of the at least one underwriting question, an indication of an answer to the at least one underwriting question; and
determining, by the specially-programmed computerized processing device and based on the answer to the at least one underwriting question, a new business classification of the business.

6. The method of claim 5, further comprising:
providing, by the specially-programmed computerized processing device and to the user device, an indication of the new business classification of the business.

7. The method of claim 1, further comprising:
receiving, by the specially-programmed computerized processing device and from the user device, an indication of a selection of at least one selected insurance policy type, wherein each selected insurance policy type comprises an available insurance policy type;
receiving, by the specially-programmed computerized processing device, an indication of a desired coverage for each selected insurance policy type; and
providing, by the specially-programmed computerized processing device and to the user device, a rate quote for each selected insurance policy type.

8. The method of claim 7, further comprising:
creating, by the specially-programmed computerized processing device, a policy for each selected insurance policy type; and
receiving, by the specially-programmed computerized processing device and from the user device, an indication that a customer desires to purchase the policy in response to the rate quote.

9. A specially-programmed computerized processing device, comprising:
a computerized processor; and
a memory in communication with the processor, the memory storing specially-programmed instructions that when executed by the computerized processor result in:
receiving, from a user device, an indication of identifying information of a business for which an underwriting product is sought;
determining, based on third-party data, a business classification of the business; and
determining at least one available insurance policy type based on the business classification.

10. The specially-programmed computerized processing device of claim 9, wherein the identifying information comprises at least one of a business account attribute, a business identifier, and a business location.

11. The specially-programmed computerized processing device of claim 9, wherein the memory stores specially-programmed instructions that when executed by the computerized processor result in the determining of the business classification, comprising:
utilizing the identifying information, by the specially-programmed computerized processing device, to query at least one database of third-party data.

12. The specially-programmed computerized processing device of claim 9, wherein the third-party data comprises standardized classification codes.

13. The specially-programmed computerized processing device of claim 9, wherein the memory stores specially-programmed instructions that when executed by the computerized processor further result in:
providing, to the user device, an indication of at least one underwriting question that is based on the business classification of the business;
receiving, from the user device in response to the providing of the at least one underwriting question, an indication of an answer to the at least one underwriting question;
determining, based on the answer to the at least one underwriting question, a new business classification of the business; and
providing, to the user device, an indication of the new business classification of the business.

14. The specially-programmed computerized processing device of claim 9, wherein the memory stores specially-programmed instructions that when executed by the computerized processor further result in:
receiving, from the user device, an indication of a selection of at least one selected insurance policy type, wherein each selected insurance policy type comprises an available insurance policy type;
receiving, from the user device, an indication of a desired coverage for each selected insurance policy type; and
providing, to the user device, a rate quote for each selected insurance policy type.

15. The specially-programmed computerized processing device of claim 14, wherein the memory stores specially-programmed instructions that when executed by the computerized processor further result in:
creating a policy for each selected insurance policy type; and
receiving, from the user device, an indication that a customer desires to purchase the policy in response to the rate quote.

16. A method, comprising:
receiving, by a specially-programmed computerized processing device and from a user device, an indication of identifying information of a business for which an underwriting product is sought;
determining, by the specially-programmed computerized processing device, a business classification of the business;
providing, by the specially-programmed computerized processing device and to the user device, an indication of at least one underwriting question that is based on the business classification of the business;
receiving, by the specially-programmed computerized processing device and from the user device in response to the providing of the at least one underwriting question, an indication of an answer to the at least one underwriting question;
determining, by the specially-programmed computerized processing device and based on the answer to the at least one underwriting question, a new business classification of the business; and
determining, by the specially-programmed computerized processing device, at least one available insurance policy type based on the business classification.

17. The method of claim 16, wherein the identifying information comprises at least one of a business account attribute, a business identifier, and a business location.

18. The method of claim 16, wherein determining the business classification of the business comprises:
receiving, by the specially-programmed computerized processing device and from the user device, an indication of a business classification.

19. The method of claim 18, wherein the indication of the business classification comprises at least one of a keyword entry, a business segment entry, a standardized classification code, and an underwriter code.

20. The method of claim 16, wherein determining the business classification of the business comprises:
utilizing the identifying information, by the specially-programmed computerized processing device, to query at least one database of third-party data.

21. The method of claim 20, wherein the third-party data comprises standardized classification codes.

22. The method of claim 16, further comprising:
receiving, by the specially-programmed computerized processing device and from the user device, an indication of a selection of at least one selected insurance policy type, wherein each selected insurance policy type comprises an available insurance policy type;
receiving, by the specially-programmed computerized processing device, an indication of a desired coverage for each selected insurance policy type; and
providing, by the specially-programmed computerized processing device and to the user device, a rate quote for each selected insurance policy type.

23. The method of claim 22, further comprising:
creating, by the specially-programmed computerized processing device, a policy for each selected insurance policy type; and
receiving, by the specially-programmed computerized processing device and from the user device, an indication that a customer desires to purchase the policy in response to the rate quote.
